(19) United States
(12) Patent Application Publication
(10) Pub. No.: US 2025/0081275 A1
(43) Pub. Date: Mar. 6, 2025

(54) INFORMATION PROCESSING METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Yun FANG, Dongguan (CN); Zhe LIU, Dongguan (CN)

(21) Appl. No.: 18/950,276

(22) Filed: Nov. 18, 2024

Related U.S. Application Data
(63) Continuation of application No. PCT/CN2022/104741, filed on Jul. 8, 2022.

(51) Int. Cl. H04W 76/20; H04W 72/1273; H04W 72/231; H04W 80/02

(52) U.S. Cl. CPC H04W 76/20; H04W 72/1273; H04W 72/231; H04W 80/02

(57) ABSTRACT

An information processing method, including: performing, by a terminal device, single-transmission reception point (TRP) transmission and/or multi-TRP transmission using a unified transmission configuration indication (TCI) state.

### CROSS-REFERENCE TO RELATED APPLICATION

This application is a Continuation application of International Application No. PCT/CN2022/104741 filed on Jul. 8, 2022, which is incorporated herein by reference in its entirety.

### TECHNICAL FIELD

The present disclosure relates to the field of communications, and more particularly, to an information processing method, a terminal device, and a network device.

### BACKGROUND

A transmission configuration indication (TCI) state can be used for indication of downlink spatial domain quasi-co-location (QCL), as well as for transmission of QCL information of time and frequency domains. However, applications of the TCI state in a new radio (NR) system have many limitations. A unified TCI state is proposed in the NR system, which can unify beam indication mechanisms of uplink and downlink.

### SUMMARY

Embodiments of the present disclosure provide an information processing method, and the method includes:

performing, by a terminal device, single-transmission reception point (TRP) transmission and/or multi-TRP transmission using a unified transmission configuration indication (TCI) state.

Embodiments of the present disclosure provide an information processing method, and the method includes:

transmitting, by a network device, first information, where the first information is used for indicating that a terminal device performs single-TRP transmission and/or multi-TRP transmission using a unified TCI state.

Embodiments of the present disclosure provide a terminal device, and the terminal device includes:

a processing unit, configured to perform single-transmission reception point (TRP) transmission and/or multi-TRP transmission using a unified transmission configuration indication (TCI) state.

Embodiments of the present disclosure provide a network device, and the network device includes:

a first transmitting unit, configured to transmit first information, where the first information is used for indicating that a terminal device performs single-TRP transmission and/or multi-TRP transmission using a unified TCI state.

Embodiments of the present disclosure provide a terminal device, which includes a processor, a memory and a transceiver. The memory is configured to store a computer program, the processor is configured to control the transceiver to communicate with other devices, and the processor is configured to call the computer program stored in the memory and run the computer program, to cause the terminal device to perform the above information processing method.

Embodiments of the present disclosure provide a network device, which includes a processor, a memory, and a transceiver. The memory is configured to store a computer program, the processor is configured to control the transceiver to communicate with other devices, and the processor is configured to call the computer program stored in the memory and run the computer program, to cause the network device to perform the above information processing method.

Embodiments of the present disclosure provide a chip, configured to implement the above information processing method.

Exemplarily, the chip includes a processor, and the processer is configured to call a computer program from a memory and run the computer program, to cause a device equipped with the chip to perform the above information processing method.

Embodiments of the present disclosure provide a computer-readable storage medium, configured to store a computer program. The computer program, when run by a device, causes the device to perform the above information processing method.

Embodiments of the present disclosure provide a computer program product, which includes computer program instructions. The computer program instructions cause a computer to perform the above information processing method.

Embodiments of the present disclosure provide a computer program. The computer program, when run on a computer, causes the computer to perform the above information processing method.

### BRIEF DESCRIPTION OF THE DRAWINGS

FIG. 1 is a schematic diagram of an application scenario according to embodiments of the present disclosure.

FIG. 2 is a schematic diagram of sDCI-mPDSCH.

FIG. 3 is a schematic diagram of mDCI-mPDSCH.

FIG. 4 is a timeline of a traditional TCI state.

FIG. 5 is a timeline of a unified TCI state.

FIG. 6 is a schematic flowchart of an information processing method according to an embodiment of the present disclosure.

FIG. 7 is a schematic flowchart of an information processing method according to another embodiment of the present disclosure.

FIG. 8 is a schematic flowchart of an information processing method according to another embodiment of the present disclosure.

FIG. 9 is a schematic flowchart of an information processing method according to an embodiment of the present disclosure.

FIG. 10 is a schematic flowchart of an information processing method according to another embodiment of the present disclosure.

FIG. 11 is a schematic block diagram of a terminal device according to an embodiment of the present disclosure.

FIG. 12 is a schematic block diagram of a terminal device according to another embodiment of the present disclosure.

FIG. 13 is a schematic block diagram of a network device according to an embodiment of the present disclosure.

FIG. 14 is a schematic block diagram of a network device according to another embodiment of the present disclosure.

FIG. 15 is a schematic diagram of sTRP/mTRP switching based on partial update.

FIG. 16 is a schematic diagram of a MAC CE.

FIG. 17A is a schematic diagram of switching to a sTRP PDSCH.

FIG. 17B is a schematic diagram of switching to a mTRP PDSCH.

FIG. 18 is a schematic diagram of a first processing method for channels other than PDSCH.

FIG. 19 is a schematic block diagram of a communication device according to embodiments of the present disclosure.

FIG. 20 is a schematic block diagram of a chip according to embodiments of the present disclosure.

FIG. 21 is a schematic block diagram of a communication system according to embodiments of the present disclosure.

### DETAILED DESCRIPTION

Technical solutions in the embodiments of the present disclosure will be described below with reference to the accompanying drawings in the embodiments of the present disclosure.

The technical solutions in the embodiments of the present disclosure may be applied to various communication systems, such as a global system of mobile communication (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial communication network (Non-Terrestrial Networks, NTN) system, a universal mobile telecommunication system (UMTS), a wireless local area network (WLAN) system, a wireless fidelity (WiFi) system, a fifth-generation communication (5th-Generation, 5G) system, or other communication systems.

Generally, the limited number of connections is supported by traditional communication systems and is easy to implement. However, with the development of the communication technology, mobile communication systems will not only support the traditional communication, but also support, for example, device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

In an implementation, a communication system in the embodiments of the present disclosure may be applied to a carrier aggregation (CA) scenario, a dual connectivity (DC) scenario, or a standalone (SA) network deployment scenario.

In an implementation, the communication system in the embodiments of the present disclosure may be applied to an unlicensed spectrum, where the unlicensed spectrum may also be considered as a shared spectrum; or the communication system in the embodiments of the present disclosure may be applied to a licensed spectrum, where the licensed spectrum may also be considered as an unshared spectrum.

Various embodiments of the present disclosure are described in combination with a network device and a terminal device. The terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, or a user apparatus.

The terminal device may be a station (STATION, ST) in WLAN, or may be a cellular phone, a cordless phone, a session initiation protocol (SIP) phone, a wireless local loop (WLL) station, or a personal digital assistant (PDA) device, a handheld device with a wireless communication function, a computing device or another processing device connected to a wireless modem, an in-vehicle device, a wearable device, a terminal device in a next-generation communication system (e.g., an NR network), or a terminal device in a future evolved public land mobile network (PLMN) network.

In the embodiments of the present disclosure, the terminal device may be deployed on land, which includes indoor or outdoor, handheld, wearable, or in-vehicle; or the terminal device may be deployed on water (e.g., on a steamship); or the terminal device may be deployed in the air (e.g., on an airplane, on a balloon, or on a satellite).

In the embodiments of the present disclosure, the terminal device may be a mobile phone, a pad, a computer with a wireless transceiving function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home.

As an example rather than a limitation, in the embodiments of the present disclosure, the terminal device may also be a wearable device. The wearable device, which may also be referred to as a wearable smart device, is a generic term for devices that are developed by intelligent design on daily wears by using wearable technology and can be worn, such as glasses, gloves, a watch, clothing, and shoes. The wearable device is a portable device that is worn directly on the body, or integrated into the user's clothing or accessories. The wearable device is not only a hardware device, but also implements powerful functions through software supporting as well as data interaction or cloud interaction. Generalized wearable smart devices includes devices that have full functions and large sizes, and may implement all or part of functions without relying on smart phones (such as a smart watch or smart glasses), and devices that focus on a certain type of application functions only and need to be used in combination with any other device (e.g., a smart phone), such as various smart bracelets or smart jewelries for monitoring physical signs.

In the embodiments of the present disclosure, the network device may be a device used for communicating with a mobile device. The network device may be an access point (AP) in WLAN, a base station (Base Transceiver Station, BTS) in GSM or CDMA, or a base station (NodeB, NB) in WCDMA; or the network device may be an evolutional base station (Evolutional Node B, eNB or eNodeB) in LTE, a relay station or an access point, a network device (gNB) in an in-vehicle device, a wearable device or an NR network, a network device in a future evolved public land mobile network (PLMN) network, or a network device in an NTN network.

As an example rather than a limitation, in the embodiments of the present disclosure, the network device may have a mobile characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on land, water, and other places.

In the embodiments of the present disclosure, the network device may provide services for a cell, and the terminal device may communicate with the network device through transmission resources (e.g., frequency domain resources, or spectrum resources) used by the cell. The cell may be a cell corresponding to the network device (e.g., the base station). The cell may belong to a macro base station or a base station corresponding to a small cell. The small cell here may include: a metro cell, a micro cell, a pico cell, a femto cell, etc. These small cells have characteristics of small coverage and low transmission power, and are applicable for providing a high-speed data transmission service.

FIG. 1 exemplarily illustrates a communication system 100. The communication system includes one network device 110 and two terminal devices 120. In an implementation, the communication system 100 may include a plurality of network devices 110, and another number of terminal devices 120 may be included within a coverage range of each network device 110, which is not limited in the embodiments of the present disclosure.

In an implementation, the communication system 100 may further include other network entities such as a mobility management entity (MME) and an access and mobility management function (AMF), which are not limited in the embodiments of the present disclosure.

The network device may further include an access network device and a core network device. That is, the wireless communication system further includes a plurality of core networks for communicating with the access network device. The access network device may be an evolutional base station (evolutional node B, abbreviated as eNB or e-NodeB), a macro base station, a micro base station (also referred to as a “small base station”), a pico base station, an access point (AP), a transmission point (TP), or a new generation base station (new generation Node B, gNodeB) in a long-term evolution (LTE) system, a next generation (mobile communication system) (e.g., next radio, NR) system or an authorized auxiliary access long-term evolution (LAA-LTE) system.

It should be understood that a device having a communication function in the network or system in the embodiments of the present disclosure may be referred to as a communication device. By taking the communication system shown in FIG. 1 as an example, communication devices may include the network device with the communication function and the terminal device with the communication function, and the network device and the terminal device may be specific devices in the embodiments of the present disclosure, which will not be repeated here. The communication devices may further include other devices in the communication system, such as a network controller, a mobility management entity, and other network entities, which are not limited in the embodiments of the present disclosure.

It should be understood that, the terms “system” and “network” are often used interchangeably herein. Herein, the term “and/or” is only a description of an association relationship of associated objects, which indicates that three relationships may exist. For example, A and/or B may mean three cases where: A exists alone, both A and B exist, and B exists alone. In addition, the character “/” herein generally indicates that associated objects before and after “/” are in an “or” relationship.

It should be understood that, “indicate” mentioned in the embodiments of the present disclosure may be direct indication, may be an indirect indication, or may represent that there is an association relationship. For example, that A indicates B may mean that A directly indicates B, for example, B may be obtained by A; or it may mean that A indirectly indicates B, for example, A indicates C, and B may be obtained by C; or it may mean that there is an association relationship between A and B.

In the description of the embodiments of the present disclosure, the term “correspond” may mean a direct or indirect correspondence between the two, or an associated relationship between the two; or it may mean a relationship of indicating and being indicated, a relationship of configuring and being configured, or the like.

In order to facilitate understanding of the technical solutions in the embodiments of the present disclosure, related technologies in the embodiments of the present disclosure will be described below. The following related technologies may be, as optional solutions, arbitrarily combined with the technical solutions in the embodiments of the present disclosure, those combined solutions all belong to the protection scope of the embodiments of the present disclosure.

### 1. Unified Transmission State Indication (e.g., Unified TCI State)

In 3GPP standardization progress, a TCI state is proposed for indication of downlink spatial domain quasi-co-location (QCL) (beam), as well as for transmission of QCL information of time and frequency domains. Exemplarily, a quasi-co-location (QCL) relationship may be simply described as a large-scale fading relationship from a certain source reference signal to a target reference signal. For the beam indication, after obtaining the QCL relationship between two source reference signals and a target reference signal from a network (NW), UE can use a received beam through which the source reference signals were previously received when receiving the target reference signal. Optionally, the beam in the embodiments of the present disclosure may also be referred to as a spatial filter or a reference signal.

However, the indication mechanism of the TCI state is only applicable to downlink channels and/or signals, and applications of the TCI state in an NR system have many limitations. In order to provide a unified uplink and downlink beam management mechanism for the NR system, a unified TCI state is proposed. Examples of new functions of the unified TCI state are as follows.

(1) Three modes of the unified TCI state are provided, which includes: a joint TCI state applicable to uplink and downlink channels as well as uplink and downlink signals; a downlink (DL) TCI state applicable to downlink channels and downlink signals only; and a uplink (UL) TCI state applicable to uplink channels and uplink signals only.

(2) Downlink channels (e.g., a part of PDCCHs and PDSCHs) and downlink signals (e.g., aperiodic channel state information reference signals (CSI-RSs)) use a same downlink transmit indication beam, using the downlink TCI state or the joint TCI state.

(3) Uplink channels (e.g., PUCCHs and PUSCHs) and uplink signals (e.g., sounding reference signals (SRSs)) use a same uplink transmit beam, using the uplink TCI state or the joint TCI state.

(4) The unified TCI state may be dynamically updated and indicated by using a media access control-control element (MAC CE) and/or downlink control information (DCI).

(5) Applicable to scenarios of carrier aggregation, a beam indication on a single component carrier (CC) may be applicable to multiple different CCs.

(6) An uplink beam indication and an uplink power control parameter may be given simultaneously through the uplink TCI state or the joint TCI state.

(7) Support inter-cell beam management.

In the unified TCI state, “unified” may be understood in a variety of meanings. First, the “unified” may mean that the unified TCI state unifies beam indication mechanisms of uplink and downlink. Since the TCI state in the NR standard may only be used for a downlink beam indication, while an uplink beam indication may use a signaling based on spatial relation information. Second, the “unified” may also mean that beams between different channels are unified. For example, under configuration of a separate DL/UL TCI state, UE considers that a downlink physical downlink control channel (PDCCH) (UE-specific) and a physical downlink shared channels (PDSCH) (UE-specific) are unified into a same beam for transmission. In addition, the UE transmits an uplink PUCCH and a PUSCH using a same beam. Under configuration of the joint TCI state, the UE considers that different channels and signals of uplink and downlink may have a good guarantee of beam symmetry, that is, symmetrical beam pairs are used for uplink and downlink communications.

In an example, parameters of radio resource control (RRC) of the unified TCI state are configured as follows.

| | |
|---|---|
| TCI-State ::= | SEQUENCE { |
| tci-StateId | TCI-StateId, |
| qcl-Type1 | QCL-Info, |
| qcl-Type2 | QCL-Info OPTIONAL, -- Need R |

...
}

| | |
|---|---|
| QCL-Info ::= | SEQUENCE { |
| cell | ServCellIndex OPTIONAL, -- Need R |
| bwp-Id | BWP-Id OPTIONAL, -- Cond CSI-RS-Indicated |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

```
  ...,
  [[
```

| | |
|---|---|
| additionalPCI-r17 | AdditionalPCIIndex-r17 OPTIONAL -- Need R |

]]
}

| | |
|---|---|
| DLorJoint-TCIState-r17 ::= | SEQUENCE { |
| tci-StateUnifiedId-r17 | TCI-StateId, |
| qcl-Type1-r17 | QCL-Info, |
| qcl-Type2-r17 | QCL-Info OPTIONAL, -- Need R |
| ul-powerControl-r17 | Uplink-powerControlId-r17 OPTIONAL, -- Need R |
| pathlossReferenceRS-Id-r17 | PUSCH-PathlossReferenceRS-Id OPTIONAL -- Need |

S
}

| | |
|---|---|
| UL-TCIState-r17 ::= | SEQUENCE { |
| ul-TCIState-Id-r17 | UL-TCIState-Id-r17, |
| servingCellId-r17 | ServCellIndex OPTIONAL, -- Need S |
| referenceSignal-r17 | CHOICE { |
| ssb-Index-r17 | SSB-Index, |
| csi-RS-Index-r17 | NZP-CSI-RS-ResourceId, |
| srs-r17 | PUCCH-SRS |

},

| | |
|---|---|
| additionalPCI-r17 | AdditionalPCIIndex-r17 OPTIONAL, -- Need R |
| ul-powerControl-r17 | Uplink-powerControlId-r17 OPTIONAL, -- Need R |
| pathlossReferenceRS-Id-r17 | PUSCH-PathlossReferenceRS-Id OPTIONAL -- Need |

S
}

However, the unified TCI state does not support multiple transmission reception points (mTRP, also referred to as multi-TRP). Therefore, it is necessary to consider how to introduce the unified TCI state under mTRP operation.

2. Transmission Schemes for mTRP PDSCH

Multiple scenarios are included in an enhancement of an mTRP PDSCH, one is for an enhance mobile broadband (eMBB) scenario, and another is for an enhancement of ultra-reliable and low latency communications. Based on the above scenarios, a variety of transmission manners for mTRP may be provided. Exemplarily, there are roughly following two different scheduling methods for implementation.

(1) sDCI-mPDSCH (Single-DCI multi-TRP): an NW schedules transmission of two PDSCHs using one piece of DCI, where the piece of DCI comes from one of two TRPs. The NW may dynamically adjust which TRP is used to transmit the piece of DCI, relatively. The two PDSCHs are transmitted through two TRPs in different manners, such as space division multiplexing (SDM), frequency division multiplexing (FDM), time division multiplexing (TDM) and other multiplexing manners. This method is suitable for TRPs that have an ideal backhaul link between them. In addition, during scheduling DCI, one or two TCI states may be included to indicate dynamic switching between sTRP (single transmission reception point) transmission and mTRP transmission. For example, when a codepoint indicated by a TCI field in the DCI indicates one TCI state, it represents the sTRP transmission. When the codepoint indicates two TCI states, it represents the mTRP transmission, and the two TCI states are divided into a first TCI state and a second TCI state by a TCI state codepoint activated by a MAC CE. Each indicated TCI state, as the first TCI state or the second TCI state, will be mapped to a specific resource for TRP transmission, such as a code division multiplex (CDM) group, a demodulation reference signal (DMRS) port, the number of transmission layers, a phase tracking reference signal (PTRS) port, a redundancy version (RV) or other contents related to PDSCH scheduling.

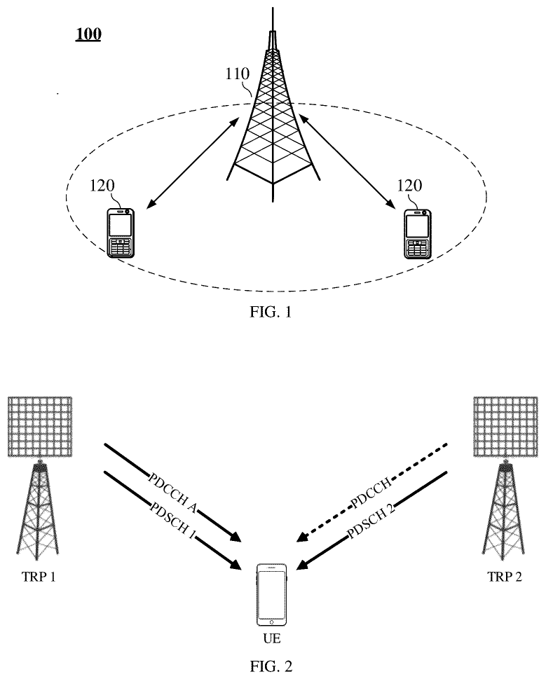

As shown in FIG. 2, a scheduling mechanism for mTRP has high flexibility, and the NW may select to transmit scheduling information of a PDCCH from TRP1 or TRP2. Based on flexibility considerations, a control resource set (CORESET) used for sDCI-mPDSCH operation does not be configured with the RRC parameter, i.e., CORESETPoolIndex.

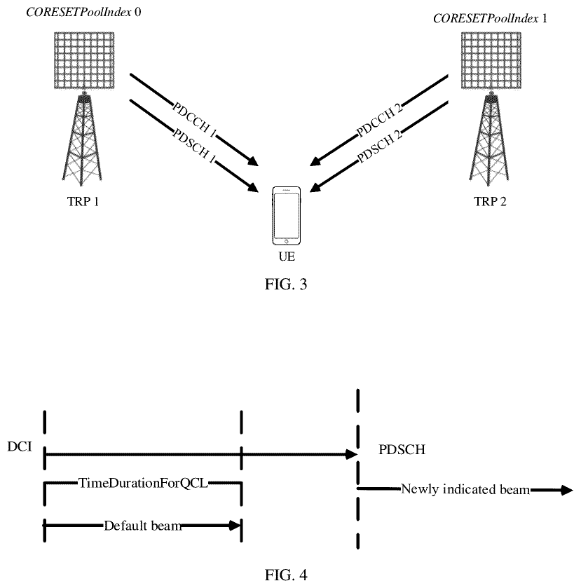

(2) mDCI-mPDSCH (multi-DCI multi-TRP): each TRP independently schedules PDSCH transmission of the TRP by transmitting a PDCCH. This operation is more suitable for a scenario where there is no ideal backhaul link between TRPs. That is, each TRP operates independently as much as possible, so as to reduce requirements for interaction between TRPs. The PDSCH transmission may be completely overlapped, partially overlapped or completely non-overlapped on time-frequency resources. Under mDCI-mPDSCH operation, the NW may configure the parameter CORESETPoolIndex for each CORESET, so as to divide multiple CORESETs into two groups, and each group corresponds to one TRP (as shown in FIG. 3). Without configuring CORESETPoolIndex, this parameter may be set to 0 by default.

If the unified TCI state is directly applied to mTRP scenarios, there may be the following problems. The unified TCI state has strong integration capabilities within one CC, that is, the downlink PDCCH/PDSCH/AP-CSI-RS and the uplink PUCCH/PUSCH/sounding reference signal (SRS) are all integrated into a same beam. However, under mTRP operation, at least two sets of independent uplink and downlink beams are required to correspond to two TRPs that are spatially separated. Therefore, it is particularly important how to find a TRP corresponding to a updated beam in a case where a MAC CE or DCI signaling indicates one unified TCI state, and how to find two TRPs corresponding the updated beam in a case where the MAC CE or DCI signaling indicates two unified TCI states.

In addition, in the scheme for sDCI-mPDSCH, a TCI state field in one piece of DCI may indicate one or two TCI states, so as to indicate the sTRP transmission or mTRP transmission. After the UE receives the DCI and successfully decodes the DCI, a TCI state indicated in the DCI is a valid value. As long as a time interval between the scheduling DCI and the PDSCH is greater than a UE capability, e.g., time duration for QCL, the UE may perform a corresponding reception using the indicated TCI state (newly indicated beam), as shown in FIG. 4. Otherwise, the NW may transmit the PDSCH using a default beam only, e.g., an active beam of a CORESET where the scheduling DCI is located.

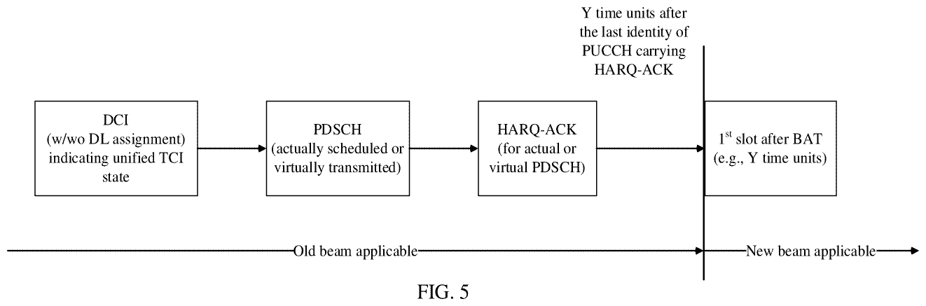

However, unlike a timeline of a traditional TCI state, a timeline of the unified TCI state is shown in FIG. 5. A unified TCI state indicated in DCI with or without PDSCH scheduling information will only take effect in a first slot after a certain beam application time (BAT) (for example, a first slot after Y time units) after the UE transmits hybrid automatic repeat request acknowledgement (HARQ-ACK) information of the PDSCH. For example, Y time units may be 7 symbols, 28 symbols, 42 symbols, 2 slots, etc. In this case, after the UE decodes a unified TCI field in the DCI, the unified TCI state has not yet taken effect before a scheduling PDSCH is received, and for beam applications, the most recently updated/indicated unified TCI state(s) are still effective. In this way, the UE cannot directly determine whether the transmission is the sTRP PDSCH transmission or mTRP PDSCH transmission according to the number of TCI states in the DCI. The embodiments of the present disclosure may provide a specific solution for how to map a relationship between a unified TCI state indicated in the DCI and a variable in the scheduling PDSCH. The variable in the PDSCH may include, for example, a DMRS port, a CDM group, or a time-frequency resource.

The embodiments of the present disclosure provide an information processing method, and the method includes:

performing, by a terminal device, single-transmission reception point (TRP) transmission and/or multi-TRP transmission using a unified transmission configuration indication (TCI) state.

In some embodiments, where performing the single-TRP transmission includes:

receiving a first transmission resource from a first TRP, or receiving a second transmission resource from a second TRP.

In some embodiments, where performing the multi-TRP transmission includes: receiving a first transmission resource from a first TRP, and receiving a second transmission resource from a second TRP.

In some embodiments, the method further includes:

receiving, by the terminal device, first information, where the first information is used for indicating that the terminal device performs the single-TRP transmission and/or multi-TRP transmission using the unified TCI state.

In some embodiments, the first information is carried by first downlink control information (DCI).

In some embodiments, the first information includes a first field in the first DCI, and the first field is used for indicating that the terminal device performs at least one of:
following a first applicable unified TCI state;
following a second applicable unified TCI state; or
following the first applicable unified TCI state and the second applicable unified TCI state.

In some embodiments, where performing, by the terminal device, the single-TRP transmission and/or multi-TRP transmission using the unified TCI state includes at least one of:
performing, by the terminal device, the single-TRP transmission using one applicable unified TCI state; or
performing, by the terminal device, the multi-TRP transmission using a plurality of applicable unified TCI states.

In some embodiments, the method further includes:

receiving, by the terminal device, second information, where the second information is used for indicating a number of unified TCI states.

In some embodiments, where performing, by the terminal device, the single-TRP transmission and/or multi-TRP transmission using the unified TCI state includes at least one of:
in a case where the number of unified TCI states is one, performing, by the terminal device, the single-TRP transmission using one applicable unified TCI state; or
in a case where the number of unified TCI states is multiple, performing, by the terminal device, the multi-TRP transmission using a plurality of applicable unified TCI states.

In some embodiments, the second information is carried by first DCI.

In some embodiments, the second information includes a second field in the first DCI, and a relationship between the number of unified TCI states indicated by the second field and a transmission type scheduled by the first DCI includes at least one of:
in a case where the number of unified TCI states indicated by the second field is one, transmission scheduled by the first DCI being the single-TRP transmission; or
in a case where the number of unified TCI states indicated by the second field is multiple, transmission scheduled by the first DCI being the multi-TRP transmission.

In some embodiments, the second information includes a third field in the first DCI, and the third field is used for indicating a unified TCI state used in a case where the number of unified TCI states is one.

In some embodiments, the first DCI is used for updating the unified TCI state applied by the terminal device after scheduling the terminal device to perform the single-TRP transmission and/or multi-TRP transmission.

In some embodiments, the method further includes:

receiving, by the terminal device, second DCI, where the second DCI is used for scheduling the terminal device to perform the single-TRP transmission and/or multi-TRP transmission after updating a unified TCI state applied by the terminal device.

In some embodiments, the first information is carried by a media access control-control element (MAC CE).

In some embodiments, the first information includes a fourth field and/or a fifth field of the MAC CE, where the fourth field is used for indicating whether a TCI codepoint includes a first unified TCI state; and the fifth field is used for indicating whether the TCI codepoint includes a second unified TCI state.

In some embodiments, where performing, by the terminal device, the single-TRP transmission and/or multi-TRP transmission using the unified TCI state includes at least one of:
in a case where first DCI indicates that a number of unified TCI states is one, responsive to that the MAC CE indicates that the TCI codepoint includes the first unified TCI state, receiving, by the terminal device, a first transmission resource from a first TRP using a first applicable unified TCI state;
in a case where the first DCI indicates that the number of unified TCI states is one, responsive to that the MAC CE indicates that the TCI codepoint includes the second unified TCI state, receiving, by the terminal device, a second transmission resource from a second TRP using a second applicable unified TCI state; or
in a case where the first DCI indicates that the number of unified TCI states is multiple, responsive to that the MAC CE indicates that the TCI codepoint includes the first unified TCI state and the second unified TCI state, receiving, by the terminal device, the first transmission resource from the first TRP using the first applicable unified TCI state and the second transmission resource from the second TRP using the second applicable unified TCI state.

In some embodiments, the MAC CE is used for indicating that the terminal device updates a first applicable unified TCI state to the first unified TCI state and/or updates a second applicable unified TCI state to the second unified TCI state.

In some embodiments, the method further includes:

in a case of receiving a physical downlink shared channel (PDSCH) from a first TRP, receiving, by the terminal device, a transmission resource other than the PDSCH from a second TRP using an applicable unified TCI state.

In some embodiments, the method further includes:

in a case of receiving a physical downlink shared channel (PDSCH) from a first TRP, receiving, by the terminal device, a transmission resource other than the PDSCH from a second TRP using a default TCI state.

In some embodiments, a determination manner for the default TCI state includes at least one of:
that the terminal device uses a downlink TCI state and/or joint TCI state corresponding to a minimum control resource set (CORESET) identifier (ID) of the second TRP within a most recent slot;
that the terminal device uses a synchronization signal block (SSB) selected when randomly accessing the second TRP as a default beam, or uses at least one of an uplink TCI state, a downlink TCI state or a joint TCI state corresponding to the SSB as the default TCI state; or
that the terminal device uses a unified TCI state, corresponding to the second TRP, among unified TCI states corresponding to a codepoint with a minimum ID in codepoints of a plurality of unified TCI states activated in a MAC CE as the default TCI state.

The embodiments of the present disclosure provide an information processing method, and the method includes:

transmitting, by a network device, first information, where the first information is used for indicating that a terminal device performs single-transmission reception point (TRP) transmission and/or multi-TRP transmission using a unified transmission configuration indication (TCI) state.

In some embodiments, the first information is carried by first downlink control information (DCI).

In some embodiments, the first information includes a first field in the first DCI, and the first field is used for indicating that the terminal device performs at least one of:
following a first applicable unified TCI state;
following a second applicable unified TCI state; or
following the first applicable unified TCI state and the second applicable unified TCI state.

In some embodiments, the first DCI is used for updating a unified TCI state applied by the terminal device after scheduling the terminal device to perform the single-TRP transmission and/or multi-TRP transmission.

In some embodiments, the method further includes:

transmitting, by the network device, second DCI, where the second DCI is used for scheduling the terminal device to perform the single-TRP transmission and/or multi-TRP transmission after updating a unified TCI state applied by the terminal device.

In some embodiments, the first information is carried by a media access control-control element (MAC CE).

In some embodiments, the first information includes a fourth field and/or a fifth field of the MAC CE, where the fourth field is used for indicating whether a TCI codepoint includes a first unified TCI state; and the fifth field is used for indicating whether the TCI codepoint includes a second unified TCI state.

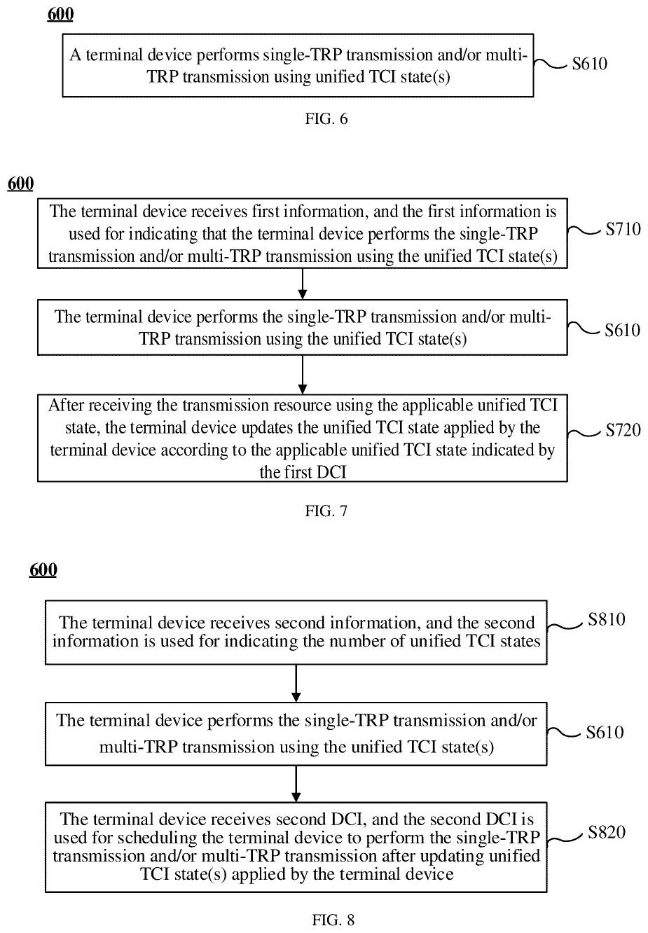

FIG. 6 is a schematic flowchart of an information processing method 600 according to an embodiment of the present disclosure. Optionally, the method may be applied to the system shown in FIG. 1, but is not limited thereto. The method includes at least some of the following contents.

In S610, a terminal device performs single-TRP transmission and/or multi-TRP transmission using unified TCI state(s).

In the embodiments of the present disclosure, the unified TCI state(s) may include at least one of an uplink TCI state, a downlink TCI state or a joint TCI state. The unified TCI state(s) may be used for indicating that the terminal device receives transmission resources such as a PDSCH from one TRP (i.e., the single-TRP transmission), or indicating that the terminal device receives transmission resources such as corresponding PDSCHs from a plurality of TRPs, respectively (i.e., the multi-TRP transmission).

In the embodiments of the present disclosure, the transmission resources received by the terminal device from the TRP(s) may include multiple types, such as PDSCH, PDCCH repetition, PUCCH time domain repetition, PUSCH time domain repetition, or multi-panel simultaneous transmission.

In an implementation, performing the single-TRP transmission includes: receiving a first transmission resource from a first TRP, or receiving a second transmission resource from a second TRP. For example, the unified TCI state(s) include a first unified TCI state, and the terminal device may receive PDSCH #1 from TRP #1 using the first unified TCI state. For another example, the unified TCI state(s) include a second unified TCI state, and the terminal device may receive PDSCH #2 from TRP #2 using the second unified TCI state.

In an implementation, performing the multi-TRP transmission includes: receiving a first transmission resource from a first TRP, and receiving a second transmission resource from a second TRP. For example, the unified TCI state(s) includes a first unified TCI state and a second unified TCI state, the terminal device may receive PDSCH #1 from TRP #1 using the first unified TCI state, and receive PDSCH #2 from TRP #2 using the second unified TCI state. Reception of two PDSCHs based on two unified TCI states is only an example but not a limitation. In actual application scenarios, more PDSCHs may be received based on more unified TCI states. In an implementation, as shown in FIG. 7, the method further includes.

In S710, the terminal device receives first information, and the first information is used for indicating that the terminal device performs the single-TRP transmission and/or multi-TRP transmission using the unified TCI state(s).

For example, the terminal device receives a PDCCH from a network device, and DCI of the PDCCH includes the first information. The first information may indicate that the terminal device performs the single-TRP transmission and/or multi-TRP transmission using the unified TCI state(s). In addition, the first information may further indicate a unified TCI state. The unified TCI state indicated by the first information is an inapplicable unified TCI state (which is referred to as an ineffective unified TCI state), a newly unified TCI state, or the like. Exemplarily, for example, the terminal device receives the DCI carrying the first information in a current slot (for example, slot 1 in which PDSCH reception is located), and an applicable unified TCI state in the current slot is different from the inapplicable unified TCI state in the DCI; and thus, the terminal device performs the single-TRP transmission and/or multi-TRP transmission using the applicable unified TCI state. After receiving PDSCH(s) from one or more TRPs, the terminal device may transmit a HARQ-ACK, and then use the unified TCI state carried in the DCI after a certain beam application time.

In an implementation, the first information is carried by first DCI. For example, the terminal device may receive a first PDCCH from the network device, and the first DCI of the first PDCCH carries the first information.

In an implementation, the first information is a first field in the first DCI, and the first field is used for indicating that the terminal device performs at least one of:
following a first applicable unified TCI state;
following a second applicable unified TCI state; or
following the first applicable unified TCI state and the second applicable unified TCI state.

In the embodiments of the present disclosure, the applicable unified TCI state may also be understood as an effective unified TCI state, for example, a TCI state that takes effect after a previous TCI state indication. After the terminal device receives DCI used for a current scheduling of the network device, a unified TCI state used in a slot for currently receiving the transmission resources such as the PDSCH is the above applicable unified TCI state. Different TRPs may correspond to different applicable unified TCI states.

For example, in the single-TRP transmission, only the first TRP needs to be used for transmission, and the first TRP corresponds to the first applicable unified TCI state indicated previously. For another example, in the single-TRP transmission, only the second TRP needs to be used for transmission, and the second TRP corresponds to the second applicable unified TCI state indicated previously. For another example, in the multi-TRP transmission, the first TRP and the second TRP need to be used for transmission, the first TRP corresponds to the first applicable unified TCI state indicated previously, and the second TRP corresponds to the second applicable unified TCI state indicated previously.

For example, in the first field in the first DCI, a codepoint for indicating an inapplicable unified TCI state may be carried. Based on a specific value of the codepoint in the first field, the terminal device may be indicated to perform a corresponding action. For example, codepoint “00” indicates that the terminal device follows the first applicable unified TCI state. For another example, codepoint “01” indicates that the terminal device follows the second applicable unified TCI state. For another example, codepoint “10” indicates that the terminal device follows the first applicable unified TCI state and the second applicable unified TCI state. The term “follow” may represent that a TCI state for indicating following is used when a certain channel is received or a certain channel is transmitted, for example, an applicable unified TCI state that is indicated by the first field for following. The applicable unified TCI state may be the TCI state that takes effect after the previous TCI state indication.

An example in which the terminal device performs the single-TRP transmission based on the first DCI is as follows. For example, if the first field in the DCI indicates to follow the first applicable unified TCI state, the terminal device may receive PDSCH #3 from TRP #3 using the first applicable unified TCI state. For another example, if the first field in the DCI indicates to follow the second applicable unified TCI state, the terminal device may receive PDSCH #4 from TRP #4 using the second applicable unified TCI state.

An example in which the terminal device performs the multi-TRP transmissions based on the first DCI is as follows. For example, if the first field in the DCI indicates to follow the first applicable unified TCI state and the second applicable unified TCI state, the terminal device may receive PDSCH #3 from TRP #3 using the first applicable unified TCI state, and receive PDSCH #4 from TRP #4 using the second applicable unified TCI state.

In an implementation, the terminal device performs the single-TRP transmission and/or multi-TRP transmission using the unified TCI state(s), which includes at least one of:
that the terminal device performs the single-TRP transmission using one applicable unified TCI state; or
that the terminal device performs the multi-TRP transmission using a plurality of applicable unified TCI states.

In the embodiments of the present disclosure, if the terminal device receives the first information, dynamic switching between the single-TRP transmission and the multi-TRP transmission may be achieved based on the first information. For example, if the DCI received by the terminal device indicates to follow one applicable unified TCI state, a PDSCH may be received from one TRP using the applicable unified TCI state. For another example, if the DCI received by the terminal device indicates to follow the plurality of applicable unified TCI states, PDSCHs may be received from respective TRPs using the plurality of applicable unified TCI states. For another example, if the DCI received by the terminal device indicates to follow the first applicable unified TCI state and the second applicable unified TCI state, a first PDSCH may be received from the first TRP using the first applicable unified TCI state, and a second PDSCH may be received from the second TRP using the second applicable unified TCI state.

In an implementation, as shown in FIG. 7, the method further includes.

In S720, after receiving the transmission resource using the applicable unified TCI state, the terminal device updates the unified TCI state applied by the terminal device according to the applicable unified TCI state indicated by the first DCI.

For example, after receiving the first DCI that indicates to follow the first applicable unified TCI state, the terminal device may receive the first PDSCH from the first TRP using the first applicable unified TCI state first. Then, after receiving the first PDSCH, the terminal device transmits HARQ-ACK information; and after a certain beam application time, the unified TCI state applied by the terminal device is updated to a first inapplicable unified TCI state carried by the first DCI.

For another example, after receiving the first DCI that indicates to follow the first applicable unified TCI state and the second applicable unified TCI state, first, the terminal device may receive the first PDSCH from the first TRP using the first applicable unified TCI state, and receive the second PDSCH from the second TRP using the second applicable unified TCI state. Then, after receiving the first PDSCH and the second PDSCH, the terminal device transmits HARQ-ACK information; and after a certain beam application time, the terminal device updates the first applicable unified TCI state to a first inapplicable unified TCI state, and updates the second applicable unified TCI state to a second inapplicable unified TCI state.

In addition, if the terminal device fails to successfully receive a PDSCH through a certain TRP, the terminal device may not update the unified TCI state corresponding to the TRP. In an implementation, as shown in FIG. 8, the method further includes.

In S810, the terminal device receives second information, and the second information is used for indicating the number of unified TCI states.

For example, the second information may include a TCI state field in the DCI, and the TCI state field is used to indicate the number of unified TCI states, e.g., the number of inapplicable unified TCI states. If the number of unified TCI states is one, the terminal device may perform the single-TRP transmission. If the number of unified TCI states is multiple, the terminal device may perform the multi-TRP transmission.

In the embodiments of the present disclosure, the terminal device may perform the single-TRP transmission and/or multiple TRP transmission using applicable unified TCI state(s) in the current slot (for example, slot 1 in which PDSCH reception is located). After receiving PDSCH(s) from one or more TRPs, the terminal device transmits HARQ-ACK information; and after a certain beam application time, the terminal device updates the applicable unified TCI state to the inapplicable unified TCI state in the DCI. Of course, the first DCI may also only include the second information without the first information. In this case, it is possible not to change a DCI format but to change a way in which the terminal device understands the DCI. The terminal device may understand a value in the TCI state field of the DCI as the number of unified TCI states, perform the TRP transmission according to the number of unified TCI states, and partially or totally update the applicable unified TCI states.

In an implementation, the terminal device performs at least one TRP transmission using the unified TCI state(s), which includes at least one of:
that in a case where the number of unified TCI states is one, the terminal device performs the single-TRP transmission using one applicable unified TCI state; or
that in a case where the number of unified TCI states is multiple, the terminal device performs the multi-TRP transmission using a plurality of applicable unified TCI states.

For example, in a case where the number of unified TCI states in the second information received by the terminal device is one, the terminal device does not use the unified TCI state indicated in the DCI currently received, but uses a default unified TCI state to perform the single-TRP transmission, e.g., to receive the PDSCH from one TRP. The default unified TCI state may be the first applicable unified TCI state indicated previously in the current slot, or may be the second applicable unified TCI state indicated previously in the current slot. After performing the single-TRP transmission, the terminal device may transmit the HARQ-ACK information to the network device, and then update the current applicable unified TCI state corresponding to the TRP to the unified TCI state indicated in the DCI after a certain BAT.

For another example, in a case where the number of unified TCI states in the second information received by the terminal device is two, the terminal device does not use the unified TCI states indicated in the DCI currently received, but uses unified TCI states indicated previously to perform the multi-TRP transmission. For example, the terminal device receives the first PDSCH from the first TRP using the first applicable unified TCI state, and receives the second PDSCH from the second TRP using the second applicable unified TCI state. After performing the multi-TRP transmission, the terminal device may transmit the HARQ-ACK information to the network device; and then, after a certain BAT, the terminal device may update the current applicable unified TCI state corresponding to the first TRP to the first unified TCI state indicated in the DCI, and update the current applicable unified TCI state corresponding to the first TRP to the second unified TCI state indicated in the DCI.

In an implementation, the second information is carried by first DCI. For example, the first information and the second information may be in the same first DCI. The terminal device may receive a PDCCH carrying the first DCI from the network device. Then, the terminal device performs the TRP transmission using the unified TCI state in the first DCI.

In an implementation, the second information includes a second field in the first DCI, and a relationship between the number of unified TCI states indicated by the second field and a transmission type scheduled by the first DCI includes at least one of:
that in a case where the number of unified TCI states indicated by the second field is one, transmission scheduled by the first DCI is the single-TRP transmission; or
that in a case where the number of unified TCI states indicated by the second field is multiple, transmission scheduled by the first DCI is the multi-TRP transmission.

In the embodiments of the present disclosure, the second field may be a TCI state field in the DCI. For example, if the number of unified TCI states indicated by the second field is one, the terminal device may schedule the single-TRP transmission based on the first DCI. For example, the terminal device receives the first PDSCH from the first TRP using the first applicable unified TCI state.

For another example, if the number of unified TCI states indicated by the second field is multiple, the terminal device may schedule the multi-TRP transmission based on the first DCI, receive the first PDSCH from the first TRP using the first applicable unified TCI state, and receive the second PDSCH from the second TRP using the second applicable unified TCI state.

In an implementation, the second information includes a third field in the first DCI, and the third field is used for indicating a unified TCI state used in a case where the number of unified TCI states is one.

For example, in a case where the number of unified TCI states indicated by the second field in the first DCI is one, the third field is set to 1, which represents that the first applicable unified TCI state is used, and the third field is set to 0, which represents that the second applicable unified TCI state is used. Here, 0 and 1 are only examples of values of the third field, rather than limitations, and the value and the number of bits of the third field may be flexibly selected according to actual needs.

In an implementation, the first DCI is used for updating the unified TCI state(s) applied by the terminal device after scheduling the terminal device to perform the single-TRP transmission and/or multi-TRP transmission.

In the embodiments of the present disclosure, the first DCI may further include scheduling information, and the first DCI is used for indicating the following unified TCI state as well as the newly unified TCI state required for updating (i.e., the inapplicable unified TCI state) while scheduling the PDSCH. If the first DCI may include scheduling information for scheduling one or more PDSCHs, the terminal device may receive one or more PDSCHs from one or more TRPs after receiving the first DCI. Then, the unified TCI state(s) applied by the terminal device are updated to unified TCI state(s) carried in the first DCI. This scheme may implement partial update of the unified TCI states, for example, only one unified TCI state or two unified TCI states carried in the first DCI may be updated.

In an implementation, as shown in FIG. 8, the method further includes.

In S820, the terminal device receives second DCI, and the second DCI is used for scheduling the terminal device to perform the single-TRP transmission and/or multi-TRP transmission after updating unified TCI state(s) applied by the terminal device.

In the embodiments of the present disclosure, the PDSCH may be scheduled after the unified TCI states are partially or totally updated. For example, the first DCI does not include the scheduling information, but mainly includes the inapplicable unified TCI state. After receiving the first DCI, the terminal device updates the unified TCI state applied by the terminal device to the unified TCI state carried in the first DCI first. Then, if receiving the second DCI including the scheduling information, the terminal device may perform the single-TRP transmission and/or multi-TRP transmission according to the scheduling information, i.e., may receive PDSCH(s) from one or more TRPs.

In an implementation, the first information is carried by a MAC CE.

In the embodiments of the present disclosure, the first information for indicating the unified TCI state may be carried not only by the DCI described above, but also by the MAC CE.

In an implementation, the first information includes a fourth field and/or a fifth field of the MAC CE; the fourth field is used for indicating whether a TCI codepoint includes a first unified TCI state, and the fifth field is used for indicating whether the TCI codepoint includes a second unified TCI state.

In an implementation, the terminal device performs the single-TRP transmission and/or multi-TRP transmission using the unified TCI state, which includes at least one of:
that in a case where first DCI indicates that the number of unified TCI states is one, responsive to that the MAC CE indicates that the TCI codepoint includes the first unified TCI state, the terminal device receives a first transmission resource from a first TRP using a first applicable unified TCI state;
that in a case where the first DCI indicates that the number of unified TCI states is one, responsive to that the MAC CE indicates that the TCI codepoint includes the second unified TCI state, the terminal device receives a second transmission resource from a second TRP using a second applicable unified TCI state; or
that in a case where the first DCI indicates that the number of unified TCI states is multiple, responsive to that the MAC CE indicates that the TCI codepoint includes the first unified TCI state and the second unified TCI state, the terminal device receives the first transmission resource from the first TRP using the first applicable unified TCI state and receives the second transmission resource from the second TRP using receives second applicable unified TCI state.

In the embodiments of the present disclosure, the fourth field and/or fifth field of the MAC CE may be used in combination with the number of unified TCI states indicated by the above second information in the DCI. For example, the second information in the DCI indicates that the number of unified TCI states is one, the fourth field of the MAC CE indicates that the TCI codepoint includes the first unified TCI state, and the fifth field of the MAC CE indicates that the TCI codepoint does not include the second unified TCI state; and thus, the first PDSCH is received from the first TRP using the first applicable unified TCI state. For another example, the second information in the DCI indicates that the number of unified TCI states is one, the fourth field of the MAC CE indicates that the TCI codepoint does not include the first unified TCI state, and the fifth field of the MAC CE indicates that the TCI codepoint includes the second unified TCI state; and thus, the second PDSCH is received from the second TRP using the second applicable unified TCI state. For another example, the second information in the DCI indicates that the number of unified TCI states is two, the fourth field of the MAC CE indicates that the TCI codepoint includes the first unified TCI state, and the fifth field of the MAC CE indicates that the TCI codepoint includes the second unified TCI state; and thus, the first PDSCH is received from the first TRP using the first applicable unified TCI state, and the second PDSCH is received from the second TRP using the second applicable unified TCI state.

In an implementation, the MAC CE is used for indicating that the terminal device updates the first applicable unified TCI state to the first unified TCI state and/or updates the second applicable unified TCI state to the second unified TCI state.

For example, after receiving the PDSCH, the terminal device may update the applicable unified TCI state based on the TCI codepoint indicated in the MAC CE. If the fourth field of the MAC CE indicates that the TCI codepoint includes the first unified TCI state, the first applicable TCI state is updated to the first unified TCI state. If the fifth field of the MAC CE indicates that the TCI codepoint includes the second unified TCI state, the second applicable TCI state is updated to the second unified TCI state.

In an implementation, the unified TCI state may be updated using the MAC CE first, and then transmission resources such as the PDSCH may be scheduled using the DCI. For example, if the fourth field of the MAC CE received by the terminal device indicates that the TCI codepoint includes the first unified TCI state, the terminal device updates the first applicable unified TCI state to the first unified TCI state. If the fifth field of the MAC CE received by the terminal device indicates whether the TCI codepoint includes the second unified TCI state, the terminal device updates the first applicable unified TCI state to the first unified TCI state. Then, the network device transmits the DCI to the terminal device, so as to schedule the transmission resources such as the PDSCH.

In an implementation, the method further includes: in a case of receiving a PDSCH from the first TRP, receiving, by the terminal device, a transmission resource other than the PDSCH from the second TRP using an applicable unified TCI state.

In the embodiments of the present disclosure, the TRP transmission may be applicable to not only the PDSCH but also other transmission resources, such as downlink PDCCH repetition, uplink PUCCH/PUSCH time domain repetition, or multi-panel simultaneous transmission (for example, a FDM or SDM scheme). Under the scenario of multi-TRP transmission, each TRP has a corresponding TCI state, i.e., has a different transmit and receive beam direction. If the PDSCH is received from the first TRP using the first applicable unified TCI state or the inapplicable unified TCI state, and the transmission resource other than the PDSCH may be received from the second TRP using the second applicable unified TCI state.

In an implementation, the method further includes:

in a case of receiving a PDSCH from the first TRP, receiving, by the terminal device, a transmission resource other than the PDSCH from the second TRP using a default TCI state.

Under the scenario of multi-TRP transmission, if the PDSCH is received from the first TRP using the applicable unified TCI state, the transmission resource other than the PDSCH may be received from the second TRP using the default TCI state. If there are more transmission resources other than the PDSCH, the transmission resources other than the PDSCH may be received from multiple corresponding TRPs using multiple default TCI states, respectively.

In an implementation, a determination manner for the default TCI state includes at least one of:
that the terminal device uses a downlink TCI state and/or joint TCI state corresponding to the minimum control resource set (CORESET) identifier (ID) of the second TRP within the most recent slot;
that the terminal device uses a synchronization signal block (SSB) selected when randomly accessing the second TRP as a default beam, or uses at least one of an uplink TCI state, a downlink TCI state or a joint TCI state corresponding to the SSB as the default TCI state; or
that the terminal device uses a unified TCI state, corresponding to the second TRP, among unified TCI states corresponding to a codepoint with the minimum ID in codepoints of a plurality of unified TCI states activated in a MAC CE as the default TCI state.

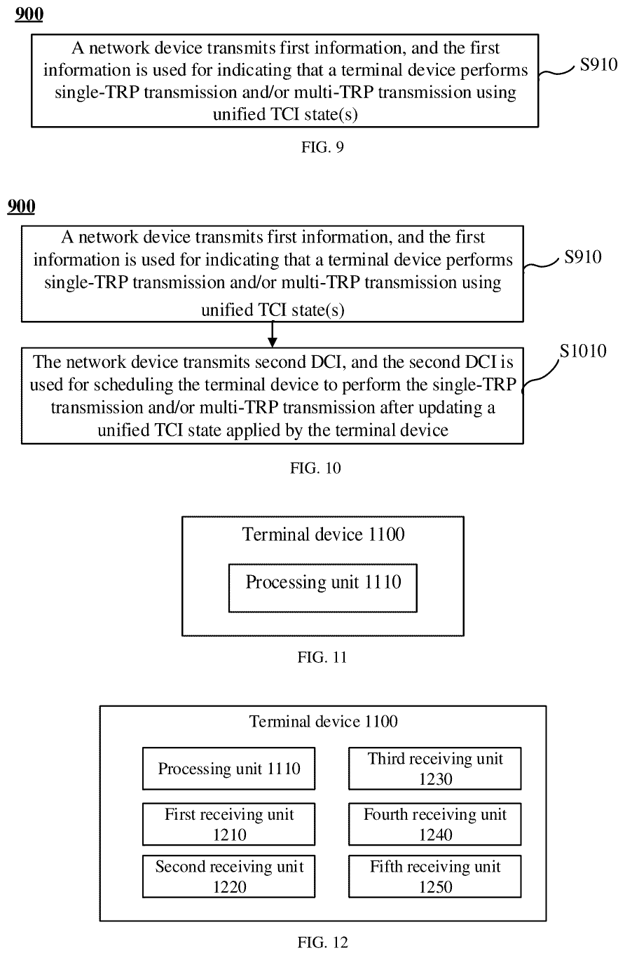

FIG. 9 is a schematic flowchart of an information processing method 900 according to an embodiment of the present disclosure. Optionally, the method may be applied to the system shown in FIG. 1, but is not limited thereto. The method includes at least some of the following contents.

In S910, a network device transmits first information, and the first information is used for indicating that a terminal device performs single-TRP transmission and/or multi-TRP transmission using unified TCI state(s).

In an implementation, the first information is carried by first DCI.

In an implementation, the first information includes a first field in the first DCI, and the first field is used for indicating that the terminal device performs at least one of:
following a first applicable unified TCI state;
following a second applicable unified TCI state; or
following the first applicable unified TCI state and the second applicable unified TCI state.

In an implementation, an inapplicable unified TCI state is used for updating a unified TCI state applied by the terminal device after the terminal device receives a transmission resource by using the inapplicable unified TCI state.

In an implementation, the first information is carried by a MAC CE.

In an implementation, the first information includes a fourth field and/or a fifth field of the MAC CE; the fourth field is used for indicating whether a TCI codepoint includes a first unified TCI state, and the fifth field is used for indicating whether the TCI codepoint includes a second unified TCI state.

In an implementation, the first DCI is used for updating a unified TCI state applied by the terminal device after scheduling the terminal device to perform the single-TRP transmission and/or multi-TRP transmission.

In an implementation, as shown in FIG. 10, the method further includes.

In S1010, the network device transmits second DCI, and the second DCI is used for scheduling the terminal device to perform the single-TRP transmission and/or multi-TRP transmission after updating a unified TCI state applied by the terminal device.

Specific examples of the method 900 performed by the network device in the embodiment may reference the related description about the network device in the above method 700, which will not be repeated here for the sake of brevity.

FIG. 11 is a schematic block diagram of a terminal device 1100 according to an embodiment of the present disclosure. The terminal device 1100 may include a processing unit 1110, configured to perform single-transmission reception point (TRP) transmission and/or multi-TRP transmission using a unified transmission configuration indication (TCI) state.

In an implementation, performing the single-TRP transmission includes: receiving a first transmission resource from a first TRP, or receiving a second transmission resource from a second TRP.

In an implementation, performing the multi-TRP transmission includes: receiving a first transmission resource from a first TRP and receiving a second transmission resource from a second TRP.

In an implementation, as shown in FIG. 12, the terminal device further includes a first receiving unit 1210, configured to receive first information. The first information is used for indicating that the terminal device performs the single-TRP transmission and/or multi-TRP transmission using the unified TCI state.

In an implementation, the first information is carried by first DCI.

In an implementation, the first information includes a first field in the first DCI, and the first field is used for indicating that the terminal device performs at least one of:
following a first applicable unified TCI state;
following a second applicable unified TCI state; or
following the first applicable unified TCI state and the second applicable unified TCI state.

In an implementation, the processing unit is further configured to implement at least one of:
that the terminal device performs the single-TRP transmission using one applicable unified TCI state; or
that the terminal device performs the multi-TRP transmission using a plurality of applicable unified TCI states.

In an implementation, the processing unit is further configured to update, after receiving the transmission resource using the applicable unified TCI state, the unified TCI state applied by the terminal device according to an inapplicable unified TCI state indicated by the first DCI.

In an implementation, as shown in FIG. 12, the terminal device further includes:

a second receiving unit 1220, configured to receive second information, where the second information is used for indicating the number of unified TCI states.

In an implementation, the unified TCI state is an applicable unified TCI state.

In an implementation, the processing unit is further configured to implement at least one of:
that in a case where the number of unified TCI states is one, the terminal device performs the single-TRP transmission using one applicable unified TCI state; or
that in a case where the number of unified TCI states is multiple, the terminal device performs the multi-TRP transmission using a plurality of applicable unified TCI states.

In an implementation, the second information is carried by first DCI.

In an implementation, the second information includes a second field in the first DCI, and a relationship between the number of unified TCI states indicated by the second field and a transmission type scheduled by the first DCI includes at least one of:
that in a case where the number of unified TCI states indicated by the second field is one, transmission scheduled by the first DCI is the single-TRP transmission; or
that in a case where the number of unified TCI states indicated by the second field is multiple, transmission scheduled by the first DCI is the multi-TRP transmission.

In an implementation, the second information includes a third field in the first DCI, and the third field is used for indicating a unified TCI state used in a case where the number of unified TCI states is one.

In an implementation, the first DCI is used for updating a unified TCI state applied by the terminal device after scheduling the terminal device to perform the single-TRP transmission and/or multi-TRP transmission.

In an implementation, the terminal device further includes a third receiving unit 1230, configured to receive second DCI. The second DCI is used for scheduling the terminal device to perform the single-TRP transmission and/or multi-TRP transmission after updating a unified TCI state applied by the terminal device.

In an implementation, the first information is carried by a MAC CE.

In an implementation, the first information includes a fourth field and/or a fifth field of the MAC CE; the fourth field is used for indicating whether a TCI codepoint includes a first unified TCI state, and the fifth field is used for indicating whether the TCI codepoint includes a second unified TCI state.

In an implementation, the processing unit is further configured to implement at least one of:
that in a case where the first DCI indicates that the number of unified TCI states is one, responsive to that the MAC CE indicates that the TCI codepoint includes the first unified TCI state, the terminal device receives a first transmission resource from a first TRP using a first applicable unified TCI state;
that in a case where the first DCI indicates that the number of unified TCI states is one, responsive to that the MAC CE indicates that the TCI codepoint includes the second unified TCI state, the terminal device receives a second transmission resource from a second TRP using a second applicable unified TCI state; or
that in a case where the first DCI indicates that the number of unified TCI states is multiple, responsive to that the MAC CE indicates that the TCI codepoint includes the first unified TCI state and the second unified TCI state, the terminal device receives the first transmission resource from the first TRP using the first applicable unified TCI state and receives the second transmission resource from the second TRP using the second applicable unified TCI state.

In an implementation, the MAC CE is used for indicating that the terminal device updates the first applicable unified TCI state to the first unified TCI state and/or updates the second applicable unified TCI state to the second unified TCI state.

In an implementation, the terminal device further include: a fourth receiving unit 1240, configured to receive, in a case of receiving a PDSCH from the first TRP, a transmission resource other than the PDSCH from the second TRP using an applicable unified TCI state.

In an implementation, the device further includes a fifth receiving unit 1250, configured to receive, in a case of receiving a PDSCH from the first TRP, a transmission resource other than the PDSCH from the second TRP using a default TCI state.

In an implementation, a determination manner for the default TCI state includes at least one of:
that the terminal device uses a downlink TCI state and/or joint TCI state corresponding to the minimum control resource set (CORESET) identifier (ID) of the second TRP within the most recent slot;
that the terminal device uses an SSB selected when randomly accessing the second TRP as a default beam, or uses at least one of an uplink TCI state, a downlink TCI state or a joint TCI state corresponding to the SSB as the default TCI state; or
that the terminal device uses a unified TCI state, corresponding to the second TRP, among unified TCI states corresponding to a codepoint with the minimum ID in codepoints of a plurality of unified TCI states activated in a MAC CE as the default TCI state.

The terminal device 1000 in the embodiments of the present disclosure may achieve corresponding functions of the terminal device in the method 600 described in the above embodiments. For processes, functions, implementations and beneficial effects corresponding to modules (submodules, units, components, or the like) in the terminal device 1100, reference may be made to the corresponding description in the above method embodiments, which will not be repeated here. It should be noted that the functions described with respect to each module (submodule, unit, component, or the like) in the terminal device 1100 in the embodiments of the present disclosure may be implemented by different modules (submodules, units, components, or the like), or may be implemented by the same module (submodule, unit, component, or the like).

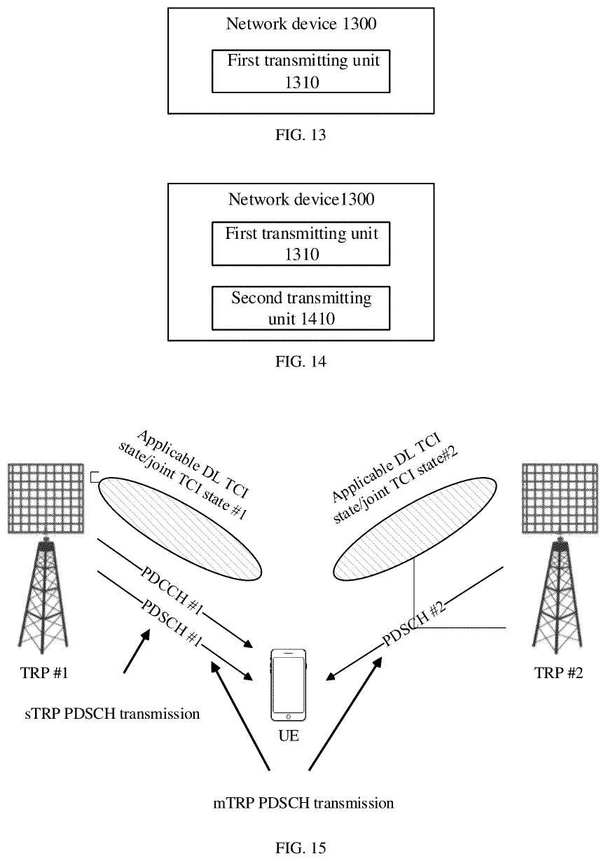

FIG. 13 is a schematic block diagram of a network device 1300 according to an embodiment of the present disclosure. The network device 1300 may include:

a first transmitting unit 1310, configured to transmit first information, where the first information is used for indicating that a terminal device performs single-TRP transmission and/or multi-TRP transmission using a unified TCI state.

In an implementation, the first information is carried by first DCI.

In an implementation, the first information includes a first field in the first DCI, and the first field is used for indicating that the terminal device performs at least one of:
following a first applicable unified TCI state;
following a second applicable unified TCI state; or
following the first applicable unified TCI state and the second applicable unified TCI state.

In an implementation, the first information is carried by a MAC CE.

In an implementation, the first information includes a fourth field and/or a fifth field of the MAC CE; the fourth field is used for indicating whether a TCI codepoint includes a first unified TCI state, and the fifth field is used for indicating whether the TCI codepoint includes a second unified TCI state.

In an implementation, the first DCI is used for updating a unified TCI state applied by the terminal device after scheduling the terminal device to perform the single-TRP transmission and/or multi-TRP transmission.

In an implementation, as shown in FIG. 14, the network device further includes:

a second transmitting unit 1410, configured to transmit second DCI, where the second DCI is used for scheduling the terminal device to perform the single-TRP transmission and/or multi-TRP transmission after updating a unified TCI state applied by the terminal device.

The network device 1300 in the embodiments of the present disclosure may achieve corresponding functions of the network device in the method 900 described in the above embodiments. For processes, functions, implementations and beneficial effects corresponding to modules (submodules, units, components, or the like) in the network device 1300, reference may be made to the corresponding description in the above method embodiments, which will not be repeated here. It should be noted that the functions described with respect to each module (submodule, unit, component, or the like) in the network device 1300 in the embodiments of the present disclosure may be implemented by different modules (submodules, units, components, or the like), or may be implemented by the same module (submodule, unit, component, or the like).

In a case where a unified TCI state is configured and indicated under a multi-TRP scenario, the embodiments of the present disclosure provide a variety of dynamic switching schemes that support downlink data channels for single-TRP transmission and multi-TRP transmission in consideration of a beam application time (also referred to as a beam effective time) of the unified TCI state, which are, for example, a scheme for enhancing DCI, a scheme for enhancing a MAC CE. In addition, under different update mechanisms of the unified TCI state, schemes for a first and/or second applicable unified TCI state are provided to support dynamic switching between sTRP PDSCH transmission and mTRP PDSCH transmission.

In the related art, in the mTRP PDSCH transmission manner, if a TCI field in a single DCI (S-DCI) indicates two TCI states (i.e., mTRP PDSCH transmission), each TCI state corresponds to one TRP; and if the TCI field in the S-DCI indicates one TCI state, the UE understands that an NW falls back the PDSCH transmission to the sTRP transmission. In the embodiments of the present disclosure, the UE may have different understandings about a unified TCI state indicated/updated in the S-DCI.

(1) Partial update: an indicated unified TCI state is only used to update a unified TCI state corresponding to a certain TRP, without affecting unified TCI states of other TRPs.

(2) Total update: indicated unified TCI states are used to update unified TCI states of all TRPs to the indicated unified TCI states.

The above different update mechanisms of the unified TCI state may be described in multiple situations, and for details, reference may be made to the following examples.

A reason for the dynamic switching between sTRP and mTRP transmission manners is as follows. If the UE is in an area (e.g., a cell edge) that is jointly covered by a plurality of TRPs, then distances between the UE and the plurality of TRPs are basically equal, and the mTRP transmission is suitable to enhance coverage of the cell edge. If the UE moves to an area that is closer to one TRP but farther away from other TRPs, then the sTRP transmission is suitable. Therefore, the dynamic switching between sTRP and mTRP based on the number of indicated TCI states may be supported. However, considering that the unified TCI state has a characteristic of beam application time (BAT) limitation, the embodiments of the present disclosure propose a scheme that can support the dynamic switching between sTRP and mTRP.

In the embodiments of the present disclosure, under the multi-TRP scenario, a dynamic switching scheme between the single-TRP and multi-TRP transmission manners may be provided based on the characteristic of beam application time of the unified TCI state.

In the embodiments of the present disclosure, when the DCI or MAC CE indicates one unified TCI state, a partial update mechanism and/or total update mechanism of the unified TCI state may be adopted.

The partial update mechanism may be to update a unified TCI state corresponding to a part of TRPs only. For example, if one unified TCI state is updated only, a codepoint of the MAC CE may be used to determine whether the updated TCI state is a first unified TCI state or a second unified TCI state corresponding to the TRP. For another example, in DCI-based TCI update, the codepoint of the MAC CE may be used to determine that a TCI field in the DCI indicates to update the first unified TCI state or the second unified TCI state. However, if there is no codepoint design for the MAC CE, when the TCI state field in the DCI indicates to update one unified TCI state, it can be clearly indicated whether to update the first unified TCI state or the second unified TCI state, corresponding to the first TRP or the second TRP, respectively.

The total update mechanism may be to update all indicated unified TCI states.

In the embodiments of the present disclosure, Example 1-1 described below proposes a DCI-based enhancement scheme to solve the BAT problem of the unified TCI state indicated in the DCI. For example, the DCI-based enhancement scheme adds a field for indicating the STRP/mTRP transmission in the DCI.

In the embodiments of the present disclosure, Example 1-2 described below proposes to perform a dynamic switching indication between sTRP PDSCH and mTRP PDSCH by a predetermined scheme using the number of TCI states indicated in the TCI field that has not taken effect yet (or referred to as has not been applied yet) in the DCI, without modifying a DCI format.

In the embodiments of the present disclosure, Example 1-3 described below proposes an enhancement scheme for the MAC CE, which means that a first unified TCI state and/or second unified TCI state of a certain TCI state codepoint is (are) activated in the MAC CE, and on this basis, by cooperating with a dynamic indication of the DCI, the dynamic switching between sTRP PDSCH and mTRP PDSCH is completed.

In the embodiments of the present disclosure, for the mechanism for updating all TCI states, Examples 2-1 and 2-2 described below provide a variety of schemes based on NW implementation to support sTRP/mTRP PDSCH.

In the embodiments of the present disclosure, Example 2-3 described below includes: in a case where the dynamic switching between sTRP PDSCH and mTRP PDSCH is performed, for other uplink and downlink channels (such as PDCCH repetition, PUCCH/PUSCH repetition or uplink multi-panel simultaneous transmission), how to maintain mTRP transmission of multiple other channels.

### Example 1: Dynamic Switching Between sTRP and mTRP Based on Partial Update of Unified TCI States

From a system perspective, in addition to the dynamic switching between sTRP and mTRP of the PDSCH, the UE has other uplink and downlink channels (e.g., PDCCH) as well as uplink and downlink signals. Here, the PDCCH transmission is independent of the PDSCH transmission and may be configured as a multi-TRP transmission scheme by the NW, e.g., PDCCH repetition or PDCCH SFN supported in Rel.17. If the DCI updates the indicated number of DL/joint TCI states of the UE from multiple to one, the PDCCH cannot operate according to the multi-TRP transmission scheme, which is also the reason why the partial update mechanism of unified TCI states is proposed.

For a missing unified TCI state that needs to be compensated by other methods, reference is made to Example 2 below.

The partial update mechanism may include: that for other channels other than the PDSCH, although only one unified TCI state (e.g., a DL TCI state/joint TCI state) is indicated in the DCI, the UE may understand that one of DL TCI states/joint TCI states maintained by multiple UEs is updated. Finally, the UEs still maintain multiple DL TCI states/joint TCI states, instead of updating the multiple states into one state. This has the advantage that the dynamical switching between sTRP and mTRP of the PDSCH may be performed without affecting the transmission manners of other uplink and downlink channels. In a case where the PDCCH indicates only one DL TCI state/joint TCI state in the DCI, the mTRP transmission (e.g., the PDCCH repetition) configured by the RRC signaling may still be maintained.

### Example 1-1: Dynamic Switching Scheme for sTRP/mTRP Based on DCI Enhancement

Considering that a delay in the beam application time of the DL TCI state/joint TCI state, the scheme in this example may release a binding relationship between the indicated DL TCI state/joint TCI state and the PDSCH transmission manner. That is, the UE does not need to determine whether the PDSCH is in the sTRP transmission or mTRP transmission based on the indicated number of DL TCI states/joint TCI states. In order to compensate for this functional deficiency, it is considered to introduce a new field with 2 bits in downlink scheduling DCI (e.g., DCI formats 1_1 and 1_2) to indicate PDSCH sTRP/mTRP transmission. The 2 bits are just an example, and the new field may be in another number of bits. The name of the indication may be, for example, FollowIndicatedTCIStatePDSCH (PDSCH following an indicated TCI state). Examples of specific codepoints of the indication and corresponding behaviors of the UE may refer to Table 1. This field indicates from which TRP the UE should receive the PDSCH using the downlink TCI state/joint TCI state currently (a slot in which PDSCH reception is located) applied.

TABLE 1
DCI new field value and corresponding UE behavior

| FollowIndicatedTCIStatePDSCH | UE behavior |
|---|---|
| 00 | Follow 1^{st} applicable TCI state |
| 01 | Follow 2^{nd} applicable TCI state |
| 10 | Follow 1^{st} and 2^{nd} applicable TCI state |
| 11 | Reserved |

Referring to FIG. 15, the UE maintains two applicable TCI states, for example, DL TCI states/joint TCI states. When the codepoint indicated by PDCCH #1 is “00”, the UE receives PDSCH #1 from TRP #1 using the 1^{st} applicable TCI state, i.e., the sTRP transmission. When the codepoint indicated by PDCCH #1 is “10”, the UE respectively receives PDSCH #1 and PDSCH #2 from TRP #1 and TRP #2 using the 1^{st} and 2^{nd} applicable TCI states, i.e., the mTRP transmission.

It should be noted that the DL TCI state/joint TCI state indicated in the DCI is updated to the applicable DL TCI state/joint TCI state after the sTRP/mTRP PDSCH transmission is performed. In addition, for the partial update scheme, if the NW has indicated unified TCI state(s) for one or more TRPs, the UE at least maintains the unified TCI state(s) corresponding to the one or more TRPs until next update, and may always support the mTRP-PDSCH or other mTRP transmission.

### Example 1-2: Dynamic Switching Scheme for sTRP/mTRP without DCI Modification

In the scheme of this example, a format of the downlink scheduling DCI may not be changed (that is, no new field is added). The UE needs to maintain two DL TCI states/joint TCI states, and each DL TCI state/joint TCI state corresponds to one TRP. Reference may also be made to the illustration in FIG. 15.

When the number of DL TCI states/joint TCI states indicated in the TCI state field in the DCI is one, the UE may understand that transmission scheduled by the DCI this time is the sTRP transmission. The UE does not use the DL TCI state/joint TCI state indicated (and ineffective) in the DCI. Instead, the UE uses the first applicable DL TCI state/joint TCI state by default or fixedly. The second applicable DL TCI state/joint TCI state may also be used by default, and only the first applicable DL TCI state/joint TCI state is described as an example, rather than a limitation.

When the number of DL TCI states/joint TCI states indicated in the TCI state field in the DCI is two, the UE may understand that transmission scheduled by the DCI this time is the mTRP transmission. The UE does not use the DL TCI states/joint TCI states indicated (and ineffective or inapplicable) in the DCI. Instead, the UE uses the two DL TCI states/joint TCI states currently (for example, a slot in which PDSCH transmission is located) applied.

In this scheme, although no new field is added in the DCI, the understanding of the UE on the original TCI state field has changed as above, and the behaviors of the UE may also be set accordingly. However, when the NW indicates one DL TCI state/joint TCI state only, if a TRP for transmitting the PDSCH is also fixed to a TRP corresponding to the first applicable DL TCI state/joint TCI state, dynamic adjustment cannot be performed.

In order to dynamically adjust the TCI state, when one unified TCI state is updated in the TCI state field in the DCI, it may be explicitly indicated in the DCI whether to update the first unified TCI state or the second unified TCI state, corresponding to the first TRP or the second TRP respectively. For example, a new field with 1 bit is set in the DCI to indicate a specific updated unified TCI state. If a value of this field is 1, it represents that the first applicable unified TCI state corresponding to the first TRP is used; and if a third field is set to 0, it represents that the second applicable unified TCI state corresponding to the second TRP is used.

In order to dynamically adjust the TCI state, MAC CE auxiliary indication may also be adopted, and reference is made to the scheme provided in Example 1-3.

### Example 1-3: Dynamic Switching Scheme for MAC CE Enhanced sTRP/mTRP

Based on the scheme of Example 1-2, it can be seen that the sTRP transmission adopts the default first or second applicable DL TCI state/joint TCI state (the default TCI state may not be adjusted dynamically); and thus, the scheme may not be able to specify a certain TRP during the sTRP transmission. In Example 1-3, a scheme for enhancing MAC CE is proposed to support specifying a specific unified TCI state used via the MAC CE when there is only one TCI state in the DCI. For example, when the unified TCI state indicated in the DCI is one, the UE is specified by the MAC CE to perform the TRP transmission using the first DL TCI state/joint TCI state, or to perform the TRP transmission using the second DL TCI state/joint TCI state. In addition, the MAC CE may also indicate that a certain codepoint corresponds to the first DL TCI state/joint TCI state and the second DL TCI state/joint TCI state.

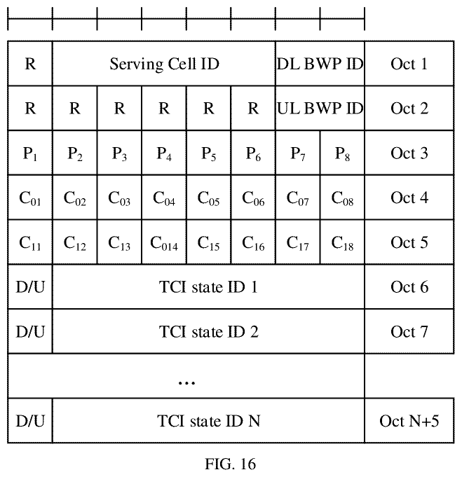

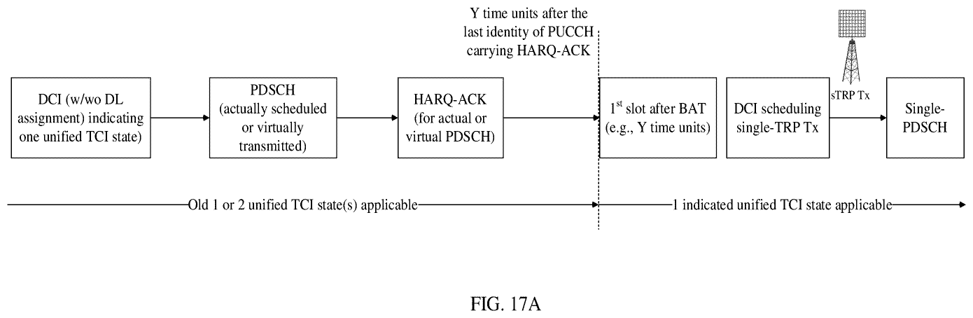

The specific MAC CE enhancement is shown in C₀₁ to C₁₈ in FIG. 16. The meanings of fields in the MAC CE are described below.

Serving Cell ID: this field indicates an identity of a serving cell for which the MAC CE applics. A length of the field is 5 bits. If the indicated serving cell is configured as part of a simultaneous U-TCI-UpdateList1, simultaneous U-TCI-UpdateList2, simultaneous U-TCI-UpdateList3 or simultaneous U-TCI-UpdateList4, this MAC CE applies to all the serving cells in the set simultaneous U-TCI-UpdateList1, simultaneous U-TCI-UpdateList2, simultaneous U-TCI-UpdateList3 or simultaneous U-TCI-UpdateList4, respectively (Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all the Serving Cells in the set simultaneousU-TCI-UpdateList1, simultaneousU-TCI-UpdateList2, simultaneousU-TCI-UpdateList3 or simultaneousU-TCI-UpdateList4, respectively).

DL BWP ID: this field indicates a DL BWP for which the MAC CE applies as a codepoint of a DCI bandwidth part indicator field. A length of the BWP ID field is 2 bits. (DL BWP ID: This field indicates a DL BWP for which the MAC CE applies as the codepoint of the DCI bandwidth part indicator field as specified in TS 38.212 [9]. The length of the BWP ID field is 2 bits).

UL BWP ID: this field indicates a UL BWP for which the MAC CE applies as a codepoint of a DCI bandwidth part indicator field. A length of the BWP ID field is 2 bits. (UL BWP ID: This field indicates a UL BWP for which the MAC CE applies as the codepoint of the DCI bandwidth part indicator field as specified in TS 38.212 [9]. The length of the BWP ID field is 2 bits).

Pᵢ: this field indicates whether each TCI codepoint has multiple TCI states or single TCI state. If Pᵢ field is set to 1, it indicates that the TCI codepoint includes the DL TCI state and the UL TCI state. If Pᵢ field is set to 0, it indicates that the TCI codepoint includes only the DL TCI state or the UL TCI state. (Pᵢ: This field indicates whether each TCI codepoint has multiple TCI states or single TCI state. If Pᵢ field set to 1, it indicates that i^{th} TCI codepoint includes the DL TCI state and the UL TCI state. If Pᵢ field set to 0, it indicates that i^{th} TCI codepoint includes only the DL TCI state or the UL TCI state).

C₀ᵢ: this filed indicates whether each TCI codepoint has multiple TCI states or single TCI state. If C₀ᵢ field is set to 1, it indicates that the i^{th} TCI codepoint includes the 1^{st} TCI state (i.e., the first unified TCI state). If C₀ᵢ field is set to 0, it indicates that the i^{th} TCI codepoint doesn't include the 1^{st} TCI state. (C₀ᵢ: This filed indicates whether each TCI codepoint has multiple TCI states or single TCI state. If C₀ᵢ field set to 1, it indicates that the i^{th} TCI codepoint includes the 1^{st} TCI state; If C₀ᵢ field set to 0, it indicates that the i^{th} TCI codepoint doesn't include the 1^{st} TCI state).

C₁ᵢ: this filed indicates whether each TCI codepoint has multiple TCI states or single TCI state. If C₁ᵢ field is set to 1, it indicates that the i^{th} TCI codepoint includes the 2^{nd} TCI state (i.e., the second unified TCI state). If C₁ᵢ field is set to 0, it indicates that the i^{th} TCI codepoint doesn't include the 2^{nd} TCI state. (C₁ᵢ: This filed indicates whether each TCI codepoint has multiple TCI states or single TCI state. If Cui field set to 1, it indicates that the i^{th} TCI codepoint includes the 2^{nd} TCI state. If C₁ᵢ field set to 0, it indicates that the i^{th} TCI codepoint doesn't include the 2^{nd} TCI state).

D/U: this field indicates whether a TCI state ID in the same octet is for a joint/downlink TCI state or uplink TCI state. If this field is set to 1, the TCI state ID in the same octet is for joint/downlink. If this field is set to 0, the TCI state ID in the same octet is for uplink. (D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink).

TCI state ID: this field indicates a TCI state identified by TCI-StateId. If D/U is set to 1, the TCI state ID with 7-bits length, i.e., TCI-StateId, is used. If D/U is set to 0, the most significant bit of the TCI state ID is a reserved bit and remainder 6 bits are UL-TCIState-Id. The maximum number of activated TCI states is 16. (TCI state ID: This field indicates the TCI state identified by TCI-StateId as specified in TS 38.331 [5]. If D/U is set to 1, 7-bits length TCI state ID, i.e., TCI-StateId as specified in TS 38.331 [5] is used. If D/U is set to 0, the most significant bit of TCI state ID is considered as the reserved bit and remainder 6 bits indicate the UL-TCIState-Id as specified in TS 38.331 [5]. The maximum number of activated TCI states is 16).

R: reserved bit, set to 0 (R: Reserved bit, set to 0).

In combination with the scheme in Example 1-2, the MAC CE enhancement may be used in combination with the DCI. Exemplarily, when the number of DL TCI states/joint TCI states indicated in the TCI state field in the DCI is one, the UE may understand that the transmission scheduled by the DCI this time is the sTRP transmission. The UE does not use the DL TCI state/joint TCI state indicated (and ineffective) in the DCI. Instead, the UE uses the first or second applicable DL TCI state/joint TCI state corresponding to the codepoint in the TCI field in the DCI. The UE determines whether the i^{th} codepoint of the TCI state corresponds to the first or second applicable DL TCI state/joint TCI state by C₀ᵢ and C₁ᵢ in the MAC CE. For example, if the value of C₀ᵢ is 1 and the value of Cui is 0, the UE performs the TRP transmission using the first applicable DL TCI state/joint TCI state corresponding to the i^{th} codepoint, receives a first PDSCH from a first TRP, and then updates the first applicable DL TCI state/joint TCI state. For another example, if the value of C₀ᵢ is 1 and the value of Cui is 0, the UE performs the TRP transmission using the second applicable DL TCI state/joint TCI state corresponding to the i^{th} codepoint, receives a second PDSCH from a second TRP, and then updates the second applicable DL TCI state/joint TCI state.

When the number of DL TCI states/joint TCI states indicated in the TCI state field in the DCI is two, the UE understands that the transmission scheduled by the DCI this time is the mTRP transmission. The UE does not use the DL TCI states/joint TCI states indicated (and ineffective or inapplicable) in the DCI. Instead, the UE performs the multi-TRP transmission using the two DL TCI states/joint TCI states currently (for example, a slot in which PDSCH transmission is located) applied. Then, the two DL TCI states/joint TCI states currently applied are updated.

### Example 2: Dynamic Switching Between sTRP and mTRP Based on Total Update of Unified TCI States

### Example 2-1: First Dynamic Switching Scheme for sTRP/mTRP Based on NW Implementation

In this embodiment, a scheme in which an indication mechanism of the unified TCI state is not modified may also be provided. Exemplarily, the NW and UE accept a fact that the beam application time of the unified TCI state is relatively long, and give a certain waiting time.

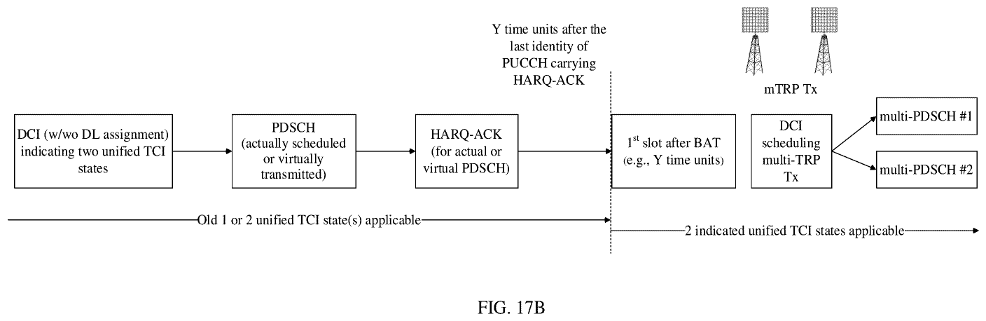

The functional division of the DCI may be considered in two situations. Referring to FIG. 17A, a first type of DCI may be DCI with downlink scheduling or without downlink scheduling (as shown on the left side of the dashed line) for an indication of the DL TCI state/joint TCI state. A second type of DCI is used for downlink scheduling of the PDSCH. For example, the second type of DCI is DCI on the left side of the dashed line, is used for scheduling the single-TRP transmission (DCI scheduling single-TRP Tx) and single PDSCH, and may include the DL TCI state/joint TCI state or may not include the DL TCI state/joint TCI state.

As shown in FIG. 17A, when the NW is preparing to switch the UE to a transmission mode of sTRP PDSCH, regardless of whether the number of DL TCI states/joint TCI states currently being applied is one or two (or more), the NW may transmit the first type of DCI to indicate one DL TCI state/joint TCI state and perform a complete effective process of beam application time (BAT). Then, the NW may transmit the second type of DCI to perform data scheduling for sTRP PDSCH. In this way, the one DL TCI state/joint TCI state being applied is just suitable for the sTRP PDSCH transmission and is also adapted to scheduling parameters of another PDSCH. For example, one unified TCI state is indicated (indicating one unified TCI state) via DCI (w/wo DL assignment). The w/wo DL assignment represents that two types of downlink DCI are supported to indicate the unified TCI state. W DL assignment is DCI with downlink scheduling information (with DL assignment); and wo DL assignment is DCI without downlink scheduling information (without DL assignment). The PDSCH is actually scheduled or virtually transmitted via the DCI. The HARQ-ACK for actual or virtual PDSCH is transmitted. In a 1^{st} slot after Y time units after the last identity of the PUCCH carrying the HARQ-ACK is transmitted (for example, Y symbols after the last symbol of PUCCH carrying HARQ-ACK), i.e., in the 1^{st} slot after BAT (i.e., Y symbols), the single-TRP transmission is scheduled by one piece of DCI (DCI scheduling single-TRP Tx). For example, Y time units may be 7 symbols, 28 symbols, 42 symbols, 2 time slots, or the like.

Similarly, as shown in FIG. 17B, when the NW is preparing to switch the UE to a transmission mode of mTRP PDSCH, regardless of whether the number of DL TCI states/joint TCI states currently being applied is one or two (or more), the NW may transmit the first type of DCI to indicate two (or more) DL TCI states/joint TCI states and perform a complete effective process of beam application time. Then, the NW may transmit the second type of DCI to perform data scheduling for mTRP PDSCH. In this way, the two DL TCI states/joint TCI states being applied are just suitable for the mTRP PDSCH transmission and are also adapted to scheduling parameters of other two PDSCHs. For example, two unified TCI states are indicated (indicating two unified TCI states) via DCI (w/wo DL assignment). The PDSCH is actually scheduled or virtually transmitted via the DCI. The HARQ-ACK for actual or virtual PDSCH is transmitted. In a 1st slot after Y time units (for example, Y symbols) after the last identity of the PUCCH carrying the HARQ-ACK is transmitted, i.e., in the 1st slot after BAT (i.e., Y symbols), the multi-TRP transmission is scheduled by one piece of DCI (DCI scheduling multi-TRP Tx). For example, Y time units may be 7 symbols, 28 symbols, 42 symbols, 2 slots, or the like. For example, PDSCH #1 is received from TRP #1 using the applicable DL TCI state/joint TCI state #1, and PDSCH #2 is received from TRP #2 using the applicable DL TCI state/joint TCI state #2.

### Example 2-2: Second Dynamic Switching Scheme for sTRP/mTRP Based on NW Implementation

For the scheme in Example 1-1 (i.e., the scheme for DCI enhancement), the NW may implement a mechanism based on the total update of unified TCI states through appropriate control. Exemplarily, when there is only one unified TCI state in the applicable state, the field (e.g., FollowIndicatedTCIStatePDSCH) in the DCI only includes codepoints ‘00’ and ‘01’ in Table 1. Similarly, when there are two unified TCI states in the applicable state, the field (e.g., FollowIndicatedTCIStatePDSCH) in the DCI may only indicate the codepoint corresponding to the multi-TRP transmission, i.e., ‘10’.

Similarly, for the schemes in Examples 1-2 and 1-3 (that is, the format of the DCI is not changed), the NW may also implement the dynamic switching between sTRP and mTRP through scheduling. Exemplarily, when there is only one unified TCI state in the applicable state, the TCI field in the DCI may only indicate one DL TCI state/joint TCI state. When there are two unified TCI states in the applicable state, the TCI field in the DCI may indicate one or two DL TCI states/joint TCI states.

### Example 2-3: mTRP Transmission of Other Uplink and Downlink Channels

Although the embodiments of the present disclosure mainly provide the dynamic switching between sTRP and mTRP of PDSCH, mTRP transmission of other uplink and downlink channels may also be provided because the unified TCI state may bind multiple channels (such as PDCCH and PDSCH) into the same beam direction.

If only one DL TCI state/joint TCI state is indicated in the DCI to switch the PDSCH to the sTRP transmission, there may still be other channels in the system that need to perform the mTRP transmission, for example, the downlink PDCCH repetition, uplink PUCCH/PUSCH time domain repetition or multi-panel simultaneous transmission (FDM or SDM scheme). In this case, the UE needs to find an available default DL TCI state/joint TCI state for another TRP (no available DL TCI state/joint TCI state for the PDSCH).

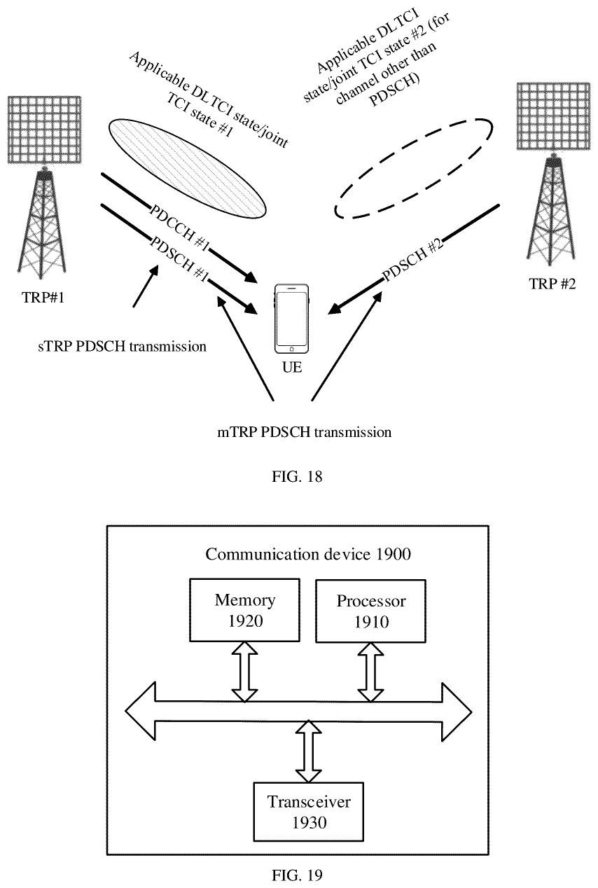

In the first manner, the UE may understand that, although only one DL TCI state/joint TCI state may be used for the PDSCH, for other downlink channels/signals other than the PDSCH (e.g., PDCCH mTRP transmission), the original DL/joint TCI state is still applicable to a TRP whose DL TCI state/joint TCI state is not updated; and for PUCCH/PUSCH mTRP transmission, the original DL TCI state/joint TCI state is still applicable to the TRP whose DL TCI state/joint TCI state is not updated. As shown in FIG. 18, the DL TCI state/joint TCI state from TRP #2 may still be applicable to other uplink and downlink channels and/or signals other than the PDSCH.

In the second manner, for the PDCCH/PUCCH/PUSCH, the original DL TCI state/joint TCI state becomes no longer applicable to the TRP whose DL TCI state/joint TCI state is not updated. In this case, it is necessary to find a default beam for a TRP that lacks the unified TCI state according to the traditional default search method. Examples of specific schemes are as follows.

(1) The UE uses the DL TCI state/joint TCI state corresponding to the minimum CORESET ID of the TRP within the most recent slot.

(2) The UE uses an SSB selected when randomly accessing the TRP as the default beam, or uses the DL TCI state/UL TCI state/joint TCI state corresponding to the SSB as the default TCI state.

(3) the UE uses a unified TCI state, corresponding to the TRP, among unified TCI states corresponding to a codepoint with the minimum ID in a plurality of codepoints including two unified TCI states activated in a MAC CE as the default TCI state.

FIG. 19 is a schematic structural diagram of a communication device 1900 according to the embodiments of the present disclosure. The communication device 1900 includes a processor 1910, and the processor 1910 may call a computer program from a memory and run the computer program, to cause the communication device 1900 to implement the methods in the embodiments of the present disclosure.

In an implementation, the communication device 1900 may further include a memory 1920. The processor 1910 may call a computer program from the memory 1920 and run the computer program, to cause the communication device 1900 to implement the methods in the embodiments of the present disclosure.

The memory 1920 may be a separate device independent from the processor 1910, or may be integrated into the processor 1910.

In an implementation, the communication device 1900 may further include a transceiver 1930, and the processor 1910 may control the transceiver 1930 to communicate with other devices, and exemplarily, to transmit information or data to other devices, or receive information or data transmitted by the other devices.

The transceiver 1930 may include a transmitter and a receiver. The transceiver 1930 may further include antenna(s). There may be one or more antennas.

In an implementation, the communication device 1900 may be the network device in the embodiments of the present disclosure, and the communication device 1900 may implement the corresponding processes implemented by the network device in various methods in the embodiments of the present disclosure, which will not be repeated here for the sake of brevity.

In an implementation, the communication device 1900 may be the terminal device in the embodiments of the present disclosure, and the communication device 1900 may implement the corresponding processes implemented by the terminal device in various methods in the embodiments of the present disclosure, which will not be repeated here for the sake of brevity.

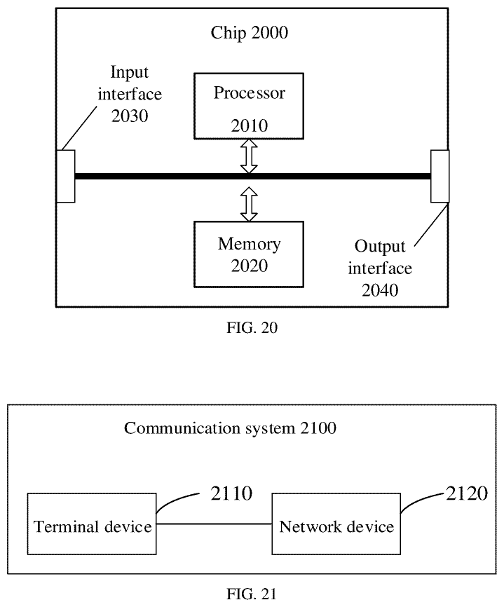

FIG. 20 is a schematic structural diagram of a chip 2000 according to the embodiments of the present disclosure. The chip 2000 includes a processor 2010, and the processor 2010 may call a computer program from a memory and run the computer program to implement the methods in the embodiments of the present disclosure.

In an implementation, the chip 2000 may further include a memory 2020. The processor 2010 may call a computer program from the memory 2020 and run the computer program to implement the methods performed by the terminal device or the network device in the embodiments of the present disclosure.

The memory 2020 may be a separate device independent from the processor 2010, or may also be integrated into the processor 2010.

In an implementation, the chip 2000 may further include an input interface 2030. The processor 2010 may control the input interface 2030 to communicate with other devices or chips, and exemplarily, to obtain information or data transmitted by other devices or chips.

In an implementation, the chip 2000 may further include an output interface 2040. The processor 2010 may control the output interface 2040 to communicate with other devices or chips, and exemplarily, to output information or data to other devices or chips.

In an implementation, the chip may be applied to the network device in the embodiments of the present disclosure, and the chip may implement the corresponding processes implemented by the network device in the various methods in the embodiments of the present disclosure, which will not be repeated here for the sake of brevity.

In an implementation, the chip may be applied to the terminal device in the embodiments of the present disclosure, and the chip may implement the corresponding processes implemented by the terminal device in the various methods in the embodiments of the present disclosure, which will not be repeated here for the sake of brevity.

The chips applied to the network device and the terminal device may be the same chip or different chips.

It should be understood that, the chip mentioned in the embodiments of the present disclosure may also be referred to as a system-level chip, a system chip, a chip system or a system-on-chip.

The processor mentioned above may be a general-purpose processor, a digital signal processor (DSP), a field programmable gate array (FPGA), an application specific integrated circuit (ASIC) or another programmable logic device, a transistor logic device, or a discrete hardware component. The general-purpose processor mentioned above may be a microprocessor or any conventional processor.

The memory mentioned above may be a volatile (transitory) memory or a non-volatile (non-transitory) memory, or may include both the volatile memory and the non-volatile memory. Here, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or flash memory. The volatile memory may be a random access memory (RAM).

It should be understood that the above memory is exemplary but not limited illustration. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct rambus random access memory (Direct Rambus RAM, DR RAM), or the like. That is, the memories in the embodiments of the present disclosure are intended to include, but not limited to, these and any other suitable types of memories.

FIG. 21 is a schematic block diagram of a communication system 2100 according to the embodiments of the present disclosure. The communication system 2100 includes a terminal device 2110 and a network device 2120.

The terminal device 2110 may be configured to implement corresponding functions implemented by the terminal device in the above methods, and the network device 2120 may be configured to implement corresponding functions implemented by the network device in the above methods, which will not be repeated here for the sake of brevity.

In the above embodiments, all or part of them may be implemented by software, hardware, firmware or any combination thereof. When implemented using software, all or part of the above embodiments may be implemented in a form of a computer program product. The computer program product includes one or more computer instructions. When the computer program instruction(s) are loaded and executed on a computer, the processes or functions described in the embodiments of the present disclosure are generated in whole or in part. The computer may be a general-purpose computer, a special purpose computer, a computer network, or any other programmable device. The computer instruction(s) may be stored in a computer-readable storage medium, or transmitted from a computer-readable storage medium to another computer-readable storage medium. For example, the computer instruction(s) may be transmitted from a website, computer, server, or data center to another website, computer, server, or data center via a wired manner (e.g., coaxial cable, optical fiber, or digital subscriber line (DSL)) or a wireless manner (e.g., infrared, wireless, or microwave). The computer-readable storage medium may be any available medium that can be read by a computer or a data storage device such as a server or a data center that includes one or more available medium. The available medium may be a magnetic medium (e.g., a floppy disk, hard disk, or magnetic tape), an optical medium (e.g., a digital video disc (DVD)), or a semiconductor medium (e.g., a solid state disk (SSD)).

It should be understood that, in the various embodiments of the present disclosure, the size of the serial numbers of the above processes does not mean the execution order. The execution order of the processes should be determined by their functions and internal logic, and should not constitute any limitation on the implementation process of the embodiments of the present disclosure.

Those skilled in the art may clearly understand that, for convenience and conciseness of description, the specific working processes of the system, devices and modules described above may refer to the corresponding processes in the above method embodiments, which will not be repeated here.

The foregoing descriptions are merely specific implementations of the present disclosure, but the protection scope of the present disclosure is not limited thereto. Any person skilled in the art may readily conceive of variations or substitutions within the technical scope disclosed in the present disclosure, which should be included within the protection scope of the present disclosure. Therefore, the protection scope of the present disclosure shall be subject to the protection scope of the claims.

What is claimed is:

1. An information processing method, comprising:
performing, by a terminal device, single-transmission reception point (TRP) transmission and/or multi-TRP transmission using a unified transmission configuration indication (TCI) state.

2. The method according to claim 1, further comprising:
receiving, by the terminal device, first information, wherein the first information is used for indicating that the terminal device performs the single-TRP transmission and/or multi-TRP transmission using the unified TCI state.

3. The method according to claim 2, wherein the first information is carried by first downlink control information (DCI); and
wherein the first information comprises a first field in the first DCI, the first field being used for indicating that the terminal device performs at least one of:
following a first applicable unified TCI state;
following a second applicable unified TCI state; or
following the first applicable unified TCI state and the second applicable unified TCI state.

4. The method according to claim 3, wherein performing, by the terminal device, the single-TRP transmission and/or multi-TRP transmission using the unified TCI state comprises at least one of:
performing, by the terminal device, the single-TRP transmission using one applicable unified TCI state; or
performing, by the terminal device, the multi-TRP transmission using a plurality of applicable unified TCI states.

5. The method according to claim 3, wherein the first DCI is used for updating the unified TCI state applied by the terminal device after scheduling the terminal device to perform the single-TRP transmission and/or multi-TRP transmission.

6. The method according to claim 1, further comprising:
receiving, by the terminal device, second information, wherein the second information is used for indicating a number of unified TCI states.

7. The method according to claim 6, wherein performing, by the terminal device, the single-TRP transmission and/or multi-TRP transmission using the unified TCI state comprises at least one of:
in a case where the number of unified TCI states is one, performing, by the terminal device, the single-TRP transmission using one applicable unified TCI state; or
in a case where the number of unified TCI states is multiple, performing, by the terminal device, the multi-TRP transmission using a plurality of applicable unified TCI states.

8. The method according to claim 6, wherein the second information is carried by first DCI; and
wherein the second information comprises a second field in the first DCI, and a relationship between the number of unified TCI states indicated by the second field and a transmission type scheduled by the first DCI comprises at least one of:
in a case where the number of unified TCI states indicated by the second field is one, transmission scheduled by the first DCI being the single-TRP transmission; or
in a case where the number of unified TCI states indicated by the second field is multiple, transmission scheduled by the first DCI being the multi-TRP transmission.

9. The method according to claim 8, wherein the first DCI is used for updating the unified TCI state applied by the terminal device after scheduling the terminal device to perform the single-TRP transmission and/or multi-TRP transmission.

10. The method according to claim 2, wherein the first information is carried by a media access control-control element (MAC CE); and
wherein the first information comprises a fourth field and/or a fifth field of the MAC CE, the fourth field being used for indicating whether a TCI codepoint comprises a first unified TCI state; and
the fifth field being used for indicating whether the TCI codepoint comprises a second unified TCI state.

11. The method according to claim 10, wherein performing, by the terminal device, the single-TRP transmission and/or multi-TRP transmission using the unified TCI state comprises at least one of:
in a case where first DCI indicates that a number of unified TCI states is one, responsive to that the MAC CE indicates that the TCI codepoint comprises the first unified TCI state, receiving, by the terminal device, a first transmission resource from a first TRP using a first applicable unified TCI state;
in a case where the first DCI indicates that the number of unified TCI states is one, responsive to that the MAC CE indicates that the TCI codepoint comprises the second unified TCI state, receiving, by the terminal device, a second transmission resource from a second TRP using a second applicable unified TCI state; or
in a case where the first DCI indicates that the number of unified TCI states is multiple, responsive to that the MAC CE indicates that the TCI codepoint comprises the first unified TCI state and the second unified TCI state, receiving, by the terminal device, the first transmission resource from the first TRP using the first applicable unified TCI state and the second transmission resource from the second TRP using the second applicable unified TCI state.

12. The method according to claim 10, wherein the MAC CE is used for indicating that the terminal device updates a first applicable unified TCI state to the first unified TCI state and/or updates a second applicable unified TCI state to the second unified TCI state.

13. The method according to claim 1, further comprising:
in a case of receiving a physical downlink shared channel (PDSCH) from a first TRP, receiving, by the terminal device, a transmission resource other than the PDSCH from a second TRP using a default TCI state;
wherein a determination manner for the default TCI state comprises at least one of:
that the terminal device uses a downlink TCI state and/or joint TCI state corresponding to a minimum control resource set (CORESET) identifier (ID) of the second TRP within a most recent slot;
that the terminal device uses a synchronization signal block (SSB) selected when randomly accessing the second TRP as a default beam, or uses at least one of an uplink TCI state, a downlink TCI state or a joint TCI state corresponding to the SSB as the default TCI state; or
that the terminal device uses a unified TCI state, corresponding to the second TRP, among unified TCI states corresponding to a codepoint with a minimum ID in codepoints of a plurality of unified TCI states activated in a MAC CE as the default TCI state.

14. A terminal device, comprising: a processor, a memory and a transceiver, wherein the memory is configured to store a computer program, the processor is configured to control the transceiver to communicate with other devices, and the processor is configured to call the computer program stored in the memory and run the computer program, to cause the terminal device to implement:
performing single-transmission reception point (TRP) transmission and/or multi-TRP transmission using a unified transmission configuration indication (TCI) state.

15. The terminal device according to claim 14, wherein the processor is configured to call the computer program stored in the memory and run the computer program, to cause the terminal device further to implement:
receiving first information, wherein the first information is used for indicating that the terminal device performs the single-TRP transmission and/or multi-TRP transmission using the unified TCI state.

16. The terminal device according to claim 14, wherein the processor is configured to call the computer program stored in the memory and run the computer program, to cause the terminal device further to implement:
receiving second information, wherein the second information is used for indicating a number of unified TCI states.

17. A network device, comprising: a processor, a memory and a transceiver, wherein the memory is configured to store a computer program, the processor is configured to control the transceiver to communicate with other devices, and the processor is configured to call the computer program stored in the memory and run the computer program, to cause the network device to implement:
transmitting first information, wherein the first information is used for indicating that a terminal device performs single-transmission reception point (TRP) transmission and/or multi-TRP transmission using a unified transmission configuration indication (TCI) state.

18. The network device according to claim 17, wherein the first information is carried by first downlink control information (DCI); and
wherein the first information comprises a first field in the first DCI, the first field being used for indicating that the terminal device performs at least one of:
following a first applicable unified TCI state;
following a second applicable unified TCI state; or
following the first applicable unified TCI state and the second applicable unified TCI state.

19. The network device according to claim 18, wherein the first DCI is used for updating a unified TCI state applied by the terminal device after scheduling the terminal device to perform the single-TRP transmission and/or multi-TRP transmission.

20. The network device according to claim 17, wherein the first information is carried by a media access control-control element (MAC CE); and
wherein the first information comprises a fourth field and/or a fifth field of the MAC CE, the fourth field being used for indicating whether a TCI codepoint comprises a first unified TCI state; and
the fifth field being used for indicating whether the TCI codepoint comprises a second unified TCI state.
